(19) United States
(12) Patent Application Publication
(10) Pub. No.: US 2014/0040040 A1
(43) Pub. Date: Feb. 6, 2014

(54) SYSTEMS AND METHODS FOR DELIVERING MESSAGE-BASED ADVERTISING AND PROVIDING CHARITABLE FUNDRAISING

(71) Applicants: Scot B. Townsend, Draper, UT (US); Jordan S. Townsend, Draper, UT (US); Ramon R. Smith, Porterville, CA (US); Daniel S. Smith, Porterville, CA (US); Jeffrey S. Taylor, Saratoga Springs, UT (US); Mark A. Mann, Lindsay, CA (US); Douglas K. Smith, Porterville, CA (US)

(72) Inventors: Scot B. Townsend, Draper, UT (US); Jordan S. Townsend, Draper, UT (US); Ramon R. Smith, Porterville, CA (US); Daniel S. Smith, Porterville, CA (US); Jeffrey S. Taylor, Saratoga Springs, UT (US); Mark A. Mann, Lindsay, CA (US); Douglas K. Smith, Porterville, CA (US)

(21) Appl. No.: 13/958,525

(22) Filed: Aug. 2, 2013

Related U.S. Application Data
(60) Provisional application No. 61/679,003, filed on Aug. 2, 2012.

(51) Int. Cl. G06Q 30/02

(52) U.S. Cl. CPC G06Q 30/0279
USPC 705/14.66

(57) ABSTRACT

A system for distributing messages to consumers. A consumer may opt-in to receive messages by sending a text message with a keyword to an aggregator. The aggregator is a message distributor and the opt-in message opts in for a particular advertiser and other advertisers. The advertiser may send messages to the consumer and other consumers who specifically opt in for the advertiser. Other advertisers may send messages to the consumer if sufficiently nearby or related to the advertiser, or if sharing a consumer cloud of the advertiser. The advertisers may manage all messages using a mobile or other interface. Messages are sent for a fee. A portion of the fee is remitted to charitable organizations identified for such purpose by recipient consumers receiving the messages. Messages sent by advertisers may include text messages, emails or instant messages.

### CROSS-REFERENCE TO RELATED APPLICATIONS

This application claims the benefit of, and priority to, U.S. Patent Application Ser. No. 61/679,003 filed on Aug. 2, 2013 and titled “SYSTEMS AND METHODS FOR DELIVERING TEXT MESSAGE ADVERTISING AND PROVIDING CHARITABLE FUNDRAISING,” which application is hereby expressly incorporated herein by this reference in its entirety.

### TECHNICAL FIELD

The present disclosure relates to communication with consumers and potential consumers. More particularly, embodiments of the present disclosure relate to software, systems and methods for sending messages, including text messages, to consumers who opt-in to receive such messages. By opting-in for messages for a particular entity (e.g., business, charity, etc.) the user may also opt-in for messages from others near the particular entity or with whom the particular entity has shared its consumer base for the purpose of providing messages. Consumers may also be enabled to manage text messages received, including by selection of a charity. A portion of all proceeds resulting from messages sent to the person may be transferred to a charity of the consumer's choice.

### BACKGROUND

Mobile devices allow consumers to move from place-to-place while also not limiting the user to any particular location (e.g., a home or office). In the context of a mobile phone, a consumer may therefore receive or make a phone call at any desired location where a suitable phone signal is present. When the mobile phone is also a so-called “smart phone” (or when the mobile device is some other portable electronic device such as a laptop, e-reader, portable media player, tablet computing device, and the like) the user may also access a variety of different programs or types of information resident on the device or over a wireless or other communication signal. Thus, a consumer can maintain productivity regardless of the consumer's particular location.

Thus, mobile phones, and particularly smart phones, now provide numerous features that do more than simply allow voice communication. A mobile phone may, for instance, include additional features such as games, calendars, calculators, browsers, productivity software, and the like. Moreover, mobile phone providers offer additional services to enhance or broaden communication options. For instance, a mobile phone provider may offer data services by which a consumer can send or receive, email, text and MMS messages, or engage in video chatting. Through data services, the user may also access networks or third party resources to browse the Internet, access a virtual private network, or otherwise access data.

Text messaging is a more recent phenomenon, and is particularly prevalent among the youth but its use is expanding across all age groups. Text messaging generally provides messages of a limited number of characters, and plans are available offering a limited number of messages per month, or even unlimited messages, so even without telephonic conversation, acquaintances may communicate. Other uses of text messaging including receiving sports scores, receiving weather reports, obtaining RSS feed updates, and even ordering food. In still other cases, text messages may be sent as advertisements. As consumers may now carry their phones with them virtually anywhere they go, text messaging offers a convenient forum for communication, particularly for short messages that can be contained within one or two text messages.

Some businesses and other entities (referred to herein as “advertisers”) may use text messaging in their advertising. For instance, a consumer may see a sign at a retail establishment, hear an advertisement, or otherwise obtain information. In response, the user can opt-in to receive text messages, typically by sending a text message to a particular location and including a keyword to identify a particular advertiser. The message may serve to allow the advertiser to thereafter send text messages to the consumer, and may include advertisements for new products or services, discounts for services or products, and the like. If the user is interested in receiving advertisements, promotions, or messages from different advertisers, the consumer must opt-in to each. Thereafter, if the user wants to stop receiving messages from any advertiser, the user typically must send another message to that advertiser by including the keyword and cancelling the service.

### SUMMARY

In accordance with aspects of the present disclosure, embodiments of methods, systems, software, computer-program products, and the like are described or would be understood and which relate to systems and methods for sending text messages, managing text message sending and receipt, and providing fundraising services. In accordance with some embodiments, such disclosure relates to the ability of a company, business, non-profit, school, municipality, or other advertiser to selectively send text messages. Text messages may be sent to consumers who have specifically opted-in for messages from that particular advertiser. An opt-in process may also allow a consumer to opt-in for receipt of additional messages from other advertisers. For instance, in a retail shopping area, a user may opt-in and become a follower of a particular store. The opt-in process may, however, also include opting in for any or all other retail locations in that particular shopping area. In some embodiments, a consumer may limit or restrict what companies have specific access to the consumer as a follower or customer, what types or how many messages can be received, and the like.

When an advertiser sends a text message, there may be a cost associated therewith (e.g., a per-message cost, a per transaction cost, a monthly subscription cost, etc.). According to some aspects of the present disclosure, a consumer may associate himself or herself with a charity. For all or some messages received by the consumer, a portion of the costs paid by the associated advertisers may be directed to the charity of the consumer's choice.

Other aspects, as well as the features and advantages of various aspects, of the present disclosure will become apparent to those of ordinary skill in the art through consideration of the ensuing description, the accompanying drawings and the appended claims.

### BRIEF DESCRIPTION OF THE DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 is a schematic illustration of example elements of a text messaging distribution system according to one embodiment of the present disclosure;

FIG. 2 is a schematic illustration of an example communication network for transmitting and receiving text messages, according to one example embodiment of the present disclosure;

FIG. 3 illustrates an example mobile electronic device opting-in for an example text messaging advertising service;

FIG. 4 illustrates an example mobile electronic device receiving text messages from a advertiser:

FIG. 5 illustrates an example view of an application on an electronic device, the view allowing a consumer or advertiser to log-in to a text messaging service;

FIG. 6 illustrates an example view of an application on an electronic device, the view allowing a consumer or advertiser to manage his or her account with a text messaging service;

FIGS. 7 and 8 illustrate example views of an application on an electronic device, the views allowing a consumer to manage his or her information and preferences related to receipt of text messages;

FIGS. 9-15 illustrate example views of an application on an electronic device, the views allowing a business to manage a text message distribution account and send text messages;

FIGS. 16-20 illustrate example views of an application on an electronic device, the views allowing a charitable organization to manage text message distribution and account information, and to view income as a result of consumers who receive text messages;

FIG. 21 illustrates a method for creating a advertiser account in a text message distribution system;

FIG. 22 illustrates a method for creating a consumer account in a text message distribution system;

FIG. 23 illustrates a method for sending text messages to one or more consumers;

FIG. 24 illustrates a method for providing a financial reward to a charity based on text messages received by supporters of the charity;

FIG. 25 illustrates a method for tracking consumers who make use of advertisements sent in text messages;

FIGS. 26-38 illustrate example views of a browser interface for allowing an entity to send text messages to consumers in accordance with some embodiments of the present disclosure;

FIGS. 39-49 illustrate example views of a mobile application interface for allowing an entity to send text messages to consumers, in accordance with another embodiment of the present disclosure; and

FIGS. 50-73 illustrate examples views of an example interface for administering an example system.

### DETAILED DESCRIPTION

Example embodiments of the present disclosure are directed to systems and methods for delivering text messages to consumers who have authorized receipt of such messages, and to optionally providing a financial reward to charities associated with the recipient consumers. More particularly, exemplary embodiments of the present disclosure are directed to systems, methods, machines, and computer-readable media usable to facilitate one or more of: (i) aggregation systems by which opting in for receipt of text messages may be shared across multiple businesses; (ii) managing text message advertisement delivery to send advertisements to a desired audience with desired demographic information; (iii) mobile management of text message delivery from a advertiser; and (iv) financial reward systems by which a monetary payment or other remuneration is delivered to a charity associated with a consumer who receives text messages.

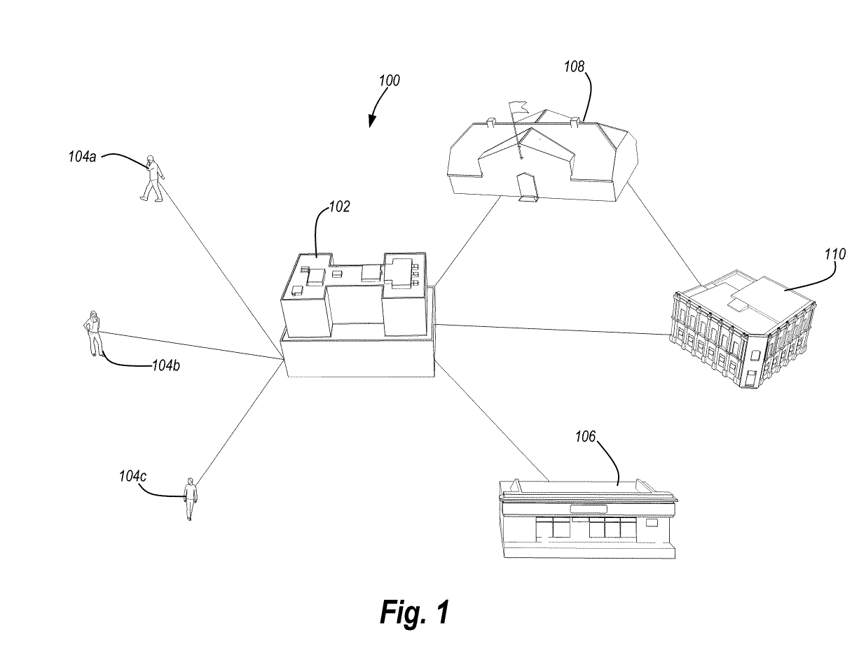

With reference now to FIG. 1A, one embodiment of a text message distribution and financial reward system 100 is illustrated. In the illustrated system 100, a variety of different entities are represented. For instance, message distributor 102, consumers 104a-104c, and an advertiser 106 are illustrated. In some embodiments, the advertiser 106 may interact with the message distributor 102 so as to allow the message distributor 102 to facilitate distribution of text messages to any or all of the consumers 104a-104c. In a particular embodiment illustrated, additional third parties 108, 110 are also illustrated within the system 100. The third parties 108, 110 may represent various types of third parties, including third parties that store or process data, third parties that process payments, third parties that receive payments, and the like.

More particularly, according to some embodiments, the advertiser 106 may represent a commercial business or other entity that may want to send text messages to portable electronic devices of the consumers 104a-104c. Such a commercial entity may include, for instance, retail, wholesale, or other commercial enterprises, and can further include restaurants, department stores, web sites, service providers, or other entities, or any combination of the foregoing, that may find it desirable to market a good, service, or other product to the consumers 104a-104c. As described in greater detail hereafter, in some embodiments, at least some of the advertisements sent to the consumers 104a-104c at the request of the advertiser 106 may be sent through the message distributor 102, and can be in the form of text messages. For instance, the message distributor 102 may be a text message aggregator, a short code provider, or some other text messaging service. In some embodiments, the message distributor 102 may provide an interface through which advertiser 106 can interact (e.g., to specify the text of the text message to be sent, how many to send, etc). The message distributor 102 may then identify which one or more consumers 104a-104c should be the recipients of the provided text message. Accordingly, in at least some aspects, the message distributor 102 may be used to send text messages and allow the identities of the consumers 104a-104c to remain unknown to the advertiser 106 and/or third parties 108, 110.

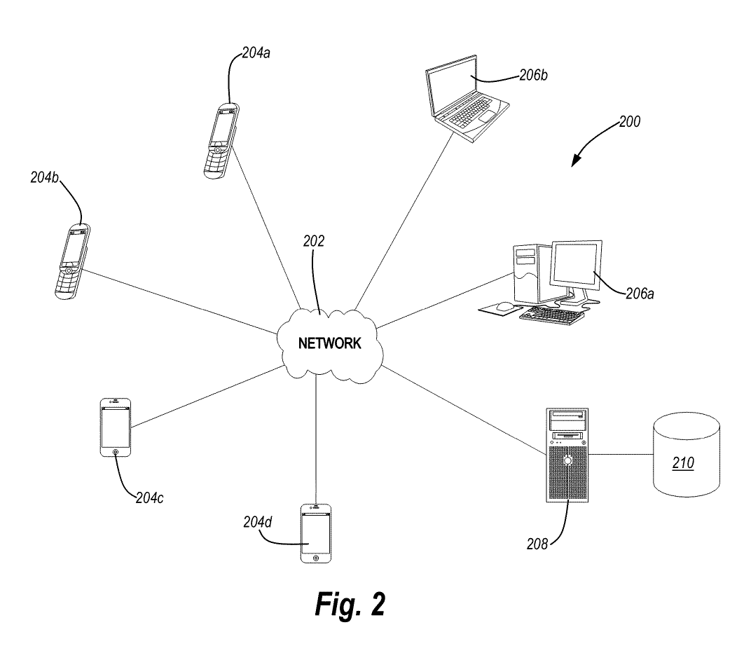

FIG. 2 schematically illustrates various devices that may communicate within a text message distribution system, including the distribution system of FIG. 1. As shown in FIG. 1, for instance, an example communication system 200 may include a network over which multiple devices 204-210 optionally communicate. Although only a few devices are illustrated, it should be appreciated that such an embodiment is illustrative only and that more or fewer devices may be included. Indeed, as with FIG. 1, multiple advertisers, third parties, consumers, and the like may be interconnected within a text message distribution system, such that potentially thousands or even millions of people electronic devices may be included within the system 200.

As illustrated in FIG. 2, message distribution system may generally include multiple mobile electronic devices 204a-204d which are capable of receiving text message or other communication through the network 202. Messages sent through the network 202 may be directed from any of a number of other devices. For instance, one mobile electronic device (e.g., device 204c) may send a text message or other communication through the network 202 to another mobile electronic device (e.g., device 204a). In other embodiments, other devices may send messages communicated through the network. By way of illustration only, the illustrated personal computing devices 206a, 206b may be used to create and/or send a message directed to one or more of the mobile electronic devices 204a-204d. Additionally, or alternatively, the server 208 may be used to send a message through the network 202 to one or more of the mobile electronic devices 204a-204d, or even to either of the personal computing devices 206a, 206b.

Although communication within the system 200 may be used to send text messages, the system 200 is not limited to sending exclusively such communications. For instance, as discussed above with respect to FIG. 1, an example text message distribution system may include an advertiser and a message distributor. In one embodiment, the personal computing device 206a may represent the advertiser while the server 208 represents the message distributor. In accordance with an example embodiment, accounts or information for each advertiser may be stored by the server 208 (e.g., directly or on data store 210). An advertiser may access its account at any time by using an application resident on the personal computer 206a, using a cloud-based application, using a distributed application, or in any other suitable manner. The account may include information about the advertiser, the costs incurred by the advertiser, past messages sent by the advertiser, information about subscribers or customers of the advertiser, and the like. Information of such type, or any other information, may be transferred over the network 202 to the personal computer 206a to allow the advertiser to view its account information at any time, even if a text message is not being created or sent.

Similarly, and as discussed in greater detail herein, embodiments of the present disclosure include aspects where charitable organizations (e.g., §401(c)(3) organizations, schools or other municipal organizations, clubs, etc.) may create accounts or otherwise be recognized by a text message distributor. In FIG. 1, the third party 108 may, for instance, be a charitable organization. Information about the organization may be maintained on the server 208 of FIG. 2 and accessible to the charitable organization (e.g., at mobile computing device 204d). In some embodiments, monetary or other financial compensation may be provided from the message distributor to the charitable organization. The compensation may be transferred via the network 202, or notices of the compensation available or provided may be available may be transferred over the network 202. Moreover, in some embodiments, the message distributor may access computing or other electronic devices of a financial institution (e.g., using the computer 206b, which can be used by third party 110 of FIG. 1). A financial institution 110 may be used to facilitate provision of compensation to one or more entities of the system 100 of FIG. 1, and may transfer or provide the compensation through the message distributor and/or network 202, or external to the network 202.

The foregoing illustrations are merely examples, and the various entities within a text message distribution system may use any number of different types of computing or other electronic devices. According to one exemplary aspect, consumers have one or more devices capable of receiving text messages. In FIG. 2, for instance, the consumers may use the mobile phone devices 204a-204d, or may also use computing devices 206a, 206b. Examples of suitable devices may therefore include mobile phones, smart phones, GPS transmitters, or another similar device capable of receiving or sending a message over a network 202. Optionally, the communication with and/or through the network 202 is provided through a communications link. Such a link may include hardwired and/or wireless technology. In an embodiment in which the devices 204a-204d include mobile phones, the devices 204a-204d may use cellular or other wireless technology to communicate over a network with the computing device 208 of the message distributor. The personal computing devices 206a, 206b may also interact with the computing device 208 of the message distributor (or of another entity). Any or all of the devices in FIG. 2 may include software, firmware, hardware, or any combination thereof so as to operate as a telephone and/or a computing device. For instance, the portable devices 204a-204d may be able to connect to the Internet and/or may run applications to facilitate communication with a message distributor (e.g., using information stored at the server 208).

As discussed in greater detail herein, the systems 100 and 200 may be used in some aspects to supply text messages to consumers 104a-104c and/or to consumer's mobile electronic devices 204a-204d, and optionally to provide for fundraising efforts for charities or other organizations associated with the consumers 104a-104c. An example method for sending text messages may include sending a text message to a consumer, charging an advertiser sending the message, and providing a portion of the charge to a charity selected by the consumer as a financial or other reward. It should be appreciated that such a method is merely illustrative. Additional and/or alternative aspects of such a method are also described elsewhere herein or may be learned in view of the disclosure herein.

In one embodiment, the consumers 104a-104c may initiate communication with, or otherwise contact, a message distributor 102. In FIG. 1, the consumers 104a-104c and the message distributor 102 may communicate through a communication link (e.g., network 202). Through such a link, the consumers 104a-104c may, in one embodiment, indicate the user's desire to receive advertisements from one or more advertisers. For instance, a user may visit a retailer that has a sign, or hear an advertisement that says something similar to: “FOR DAILY DEALS, TEXT ‘DEALS’ TO 12345”. When the user sends such a text message may initiate a registration process (although in other embodiments, a consumer may initiate a registration process without a text message by, for instance, logging in to a web site managed by the message distributor 102).

In registering, the consumers 104a-104c may provide contact information through which the consumer can receive text messages. In particular, the mobile phone number of the consumer may be identified. Through one or more return acknowledgements or additional registration, email information or other contact information could also be obtained. The message distributor 102 (e.g., through the server 208) may also communicate with one or more advertisers that wish to send advertisements. The advertiser 106 is illustrative of one such advertiser that may wish to send text message, email, or other advertisements. Through a computing device (e.g., a personal computer 206a or 206b, or through one of the mobile devices 204a-204d), the advertiser 106 may communicate with the message distributor 102. In particular, in the illustrated embodiment of FIG. 2, the various computing devices may communicate through the network 202. Through the network 202 or another communication link, the advertiser 106 may register or otherwise indicate its desire to have advertisements sent to consumers, and enlist the assistance of the message distributor 102 in directing or sending such advertisements. The advertiser 106 may be able to request that a single advertisement be distributed to a single person or to multiple people. For instance, the advertiser 106 may be able to request that an advertisement be sent to hundreds or even thousands of consumers.

According to some aspects of the present disclosure, the message distributor 102 offers a service which the advertiser 106 may pay to use. For instance, the message distributor 102 may maintain a listing of numerous consumers 106, along with their contact information. The names and contact information of the consumers 106 may be at least temporarily withheld from the advertiser 106. With the stored contact information, the message distributor 102 optionally stores other information. For instance, demographic information (e.g., age, gender, location, income level, etc.), interests and hobby information, or other information may be stored about the consumers 104a-104c.

When the message distributor 102 has received sufficient information to identify the advertisement that the advertiser 106 wishes to send, the message distributor 102 can use information about the consumers and the advertiser 106 to determine who to target with the advertisement. In some embodiments, the advertiser 106 may specify criteria for consumers to whom the advertisement can be sent. For instance, the advertiser 106 may wish to target consumers that reside in certain geographical areas, are of a certain age, gender, ethnicity, etc. The advertiser 106 may even target only consumers who self-identify as having particular interests or hobbies (e.g., sewing, sports, rock climbing, etc.), only consumers who have specifically requested deals from the advertiser, and the like. Accordingly, using the information that the message distributor 102 maintains about the various consumers, the message distributor 102 can facilitate use of the data to provide an effective means of targeting a particular audience that the advertiser 106 wishes to reach.

When the advertiser 106 has specified what information to include in an advertisement, and optionally whom to target, the message distributor 102 may access its consumer information and identify those consumers that it can target. In some cases, the advertiser 106 may request that only a limited number of advertisements be sent. For instance, the advertiser 106 may in an initial request, specify that “n” consumers should receive an advertisement. The message distributor 102 may then identify a set of “n” candidates (possibly the “best” candidates), and send the advertisement to the identified candidates (e.g., via the network 202 in the form of a text message). In other cases, the message distributor 102 may provide to the advertiser 106 a number of how many candidate consumers are available based on specified criteria. Based on that number, the advertiser 106 can determine whether to send the advertisement to some or all of the matching consumers. In some embodiments, specifying criteria and provision of a number of available consumers is provided in near real time. As an example, the advertiser 106 may use a computing device may use a browser or a cloud-based or software-as-a-service application so that information is communicated between the advertiser 106 and message distributor 102 in near real time.

In embodiments in which the message distributor 102 is a pay-to-use service, the advertisers may pay the provider to send the advertisements. According to one aspect, the advertiser 106 may pay a certain amount (e.g., between $0.005 and $0.50) per consumer to which the message distributor 102 directs an advertisement, although such payment mechanism is merely exemplary. For instance, in other embodiments, advertisers may pay a based on a flat fee, may pay different fees based on the type of business (e.g., commercial vs. non-profit), may pay different fees based on volume (e.g., with a volume discount per message), may pay different fees based on the consumers to whom a message is directed (e.g., those specifically following the advertiser vs. other consumers not following the advertiser, or for consumers who are most likely to act on the advertisement), or on some other payment schedule or plan. Regardless of the particular payment structure, such cost may vary based on a number of factors. For instance, the degree to which the advertisement is specifically tailored to a particular demographic or group, the length of the advertisement, the content of the message, the type of advertising plan the advertiser has with the provider, or other factors, or a combination of the foregoing may affect the cost paid by the advertiser. Information for payment may be transmitted from the computing device of the advertiser 106 and sent to the computing device(s) of the message distributor 102 (e.g., via network 202). The message distributor 102 may then charge the advertiser 106 (e.g., based on the number of advertisements it sends to consumers, or based on some other payment determination scheme). The charges may be applied immediately upon confirmation from the advertiser 106 that it wishes to send the advertisements, or may be delayed. For instance, the charges may be applied at the time the last advertisement is sent out, or a certain time after all advertisements have been sent out, so as to remove charges for any advertisements that do not reach the intended recipient. If some advertisements bounce-back, the message distributor 102 may, in some cases, review the available consumers and find replacement consumers to receive the advertisements. Additionally, or alternatively, a credit may be applied to the advertiser's next advertisement purchase, a cash refund may be issued, or some other refund mechanism may be provided.

When a particular consumer (e.g., consumers 104a-104c) has been identified as a consumer matching criteria specified by the advertiser 106, the message distributor 102 may send the advertisement to the consumers 104a-104c. For instance, in one embodiment, the advertisement is in the form of a text message and the advertisement is sent to a phone or other portable device 204a-204d of the consumers 104a-104c.

As noted previously, the systems 100 and 200 can, in some cases, be set-up to provide financial rewards to charitable organizations. According to at least one aspect, consumers that agree to receive advertisements may also identify one or more charities that they support. As noted above, the message distributor 102 may charge advertisers for the service it provides in matching consumers with advertisements and/or sending out advertisements on behalf of the advertisers. In some cases, a portion of the payment made to the message distributor 102 for such service may be shared with the charities supported by the consumers 104a-104c. For instance, if a consumer 104a receives 1500 text messages over a year's time and the total revenue received by the message distributor 102 for those text messages is $80.00, a portion of the $80.00 may be paid to the charity (or charities) supported by the consumer. In one embodiment, a percentage of the revenue may be paid to the charity. According to some embodiments, the percentage paid to the charity varies between 1% and 30%. In other embodiments, the percentage varies between 5% and 15%. Of course, in other embodiments, a percentage less than 1% or higher than 30% may also be paid. The foregoing is merely exemplary, however. In some embodiments, a user may select a single charity for revenue sharing, even if multiple charities are supported or followed. In other embodiments, the distribution of revenue may be accounted for in other manners. For instance, a consumer may select multiple charities and the percentage may be distributed among multiple charities, different charities may receive different percentages (e.g., charities with preferred accounts vs. charities with basic accounts), charities may be paid on something other than a percentage basis, charities may receive credits for text messaging services, or other rewards may be provided.

Where the systems 100 and 200 include an incentive or profit sharing aspect for charitable giving, the message distributor 102 may include a profit sharing component. The profit sharing component may be separate from, or incorporated within the computing device(s) of the message distributor 102. According to one aspect, a profit sharing component may be used to provide direct financial payments to charities. For instance, after a certain number of advertisements have been received by the consumers 104a-104c, or after a certain amount of money has been earned, a profit sharing component may print a check or otherwise provide a voucher that can be sent to the charity. For instance, a check may be mailed to the charity 108, or a financial payment may be made via a financial institution (e.g., institution 110). Optionally, charities can create accounts with the message distributor 102 to choose between different types of payment options.

According to at least some aspects herein, the systems 100 and 200 allow advertisers to direct advertisements to a desired group of consumers, allow consumers to receive advertisements of interest to them, allow consumers to direct funds for charitable giving, and also allow the consumers to potentially remain anonymous to the advertiser. In this manner, the message distributor 102 can act as a facilitator, while also ensuring that consumers' personal information is secure and private. In some embodiments, however, the consumers 104a-104c may be made known to the advertiser 106. For instance, a sent advertisement may include a redemption code. When that code is used to receive a discount or other promotion, the advertiser may become aware of who the consumer is. Optionally, information about redemptions is collected by the advertiser 106 and/or message distributor 102. For instance, a consumer may not receive a redemption code, but may instead visit the advertiser and show the advertiser the received message. In such a case, the advertiser could note that the consumer responded, or the consumer could potentially respond to the advertisement. Such a response could even include information about the value of products or services provided, which would allow the service provider and/or advertiser to track results and efficacy of an advertising campaign. Information about redemptions or responses to advertisements can further allow the systems 100 and 200 to potentially track consumers most likely to respond to an advertisement. Some advertisers may then wish to specifically target those consumers.

As discussed herein, one aspect of the present disclosure is the ability of consumers to opt-in to messages from a particular advertiser, and to potentially opt-in for additional related advertisements (e.g., in proximity, cross-promotions, etc.). To illustrate this point, it is useful to consider two retail stores in the same shopping center. A consumer entering a hat store may see a sign that says something like: “TEXT ‘HATS’ TO 12345 TO RECEIVE UPDATES ON NEW PRODUCTS AND PROMOTIONS.” If the consumer then follows the instructions, the consumer's information can be added to a list of consumers who have followed the same instructions and sent “HATS” to the specified location. Those consumers may be considered to be within a “cloud” that includes customers of the hat store. Thereafter, each time the hat store has a promotion, it could send text messages to its customer cloud.

Similarly, a clothing store may have a sign that says something like: “TEXT ‘KATE’ TO 12345 TO RECEIVE UPDATES ON OUR NEW PRODUCTS AND PROMOTIONS AND TO RECEIVE PROMOTIONS FROM OTHER NEARBY COMPANIES.” If the consumer then follows the instructions, the consumer's information can be added to a list of consumers who followed the same instructions and sent “KATE” to the specified location. Those consumers may be added to a cloud specific to that clothing store. Additionally, or alternatively, the consumer's opt-in message with the word “KATE” can cause the consumer to added to a recipient pool to receive advertisements from other nearby companies. Such consumers may, therefore, also be added to a general cloud that may not necessarily be associated with any single advertiser. In one embodiment, the general cloud may instead be associated with a particular geographic location. The cloud may also be associated with other criteria. For instance, rather than opting in for nearby promotions, users could opt-in for promotions from corporate sponsors, strategic partners, and the like.

In embodiments where text messages are sent based on the consumer opting in, the consumers may also be able to opt-out at a given time. To opt out, consumers may be able to respond to or sent a text message, or potentially access an online account to delete himself or herself from certain clouds, to blacklist certain advertisers, to limit what types of promotions to receive, and the like.

FIGS. 1 and 2 and the discussions related thereto are provided primarily to illustrate some example aspects of an advertisement and charitable giving system according to one aspect of the present disclosure. Additional or alternative aspects may also be included. Some such aspects are discussed hereafter, or may otherwise be learned from practice of the embodiments as disclosed herein.

While FIGS. 1 and 2 illustrate various computing devices and components, it should be appreciated that such devices and components are merely for illustration and are not intended to limit the practice or scope of the present disclosure. For instance, the computing device 108 may or may not be a server, and could be associated with a message distributor 102, an advertiser 106, or some third party. Similarly, mobile devices 204a-204d could be used by consumers 104a-104c, but could also be used by advertisers 106, charities 108, third parties 110, the message distributor 102, or other entities. Any computing device used may therefore include mobile or stationary devices, including server systems, and such devices may execute one or more programs, modules, services, routines, etc. to operate in accordance with various different aspects disclosed herein. In some embodiments, the illustrated computing devices may be single physical devices, although in other embodiments, multiple devices may be used. For instance, the server 208 may represent a set of servers, processors, devices, etc. that collectively operates to perform aspects disclosed herein. In one embodiment, the server 208 and/or network 202 is a distributed network or cloud. Thus, any computing device used within the systems of FIG. 1 or 2 may use localized processing, distributed processing, cloud-based processing, or any other type of processing or communication.

While embodiments discussed herein are described in the context of messaging systems, and particularly systems for sending so-called text messages, it should be appreciated that such an embodiment is merely illustrative. For instance, instead of subscribing to receive text messages, users may instead subscribe to receive email messages, instant messages from any of a number of different providers (e.g., Google, AOL, MSN, Blackberry, Apple, etc.) or other messages (e.g., Voxer messages, and the like). Moreover, while such different message protocols may be alternatives, they may also be combined. For instance, a consumer may provide a phone number and email address and accept messages through multiple messaging protocols. Regardless of the messaging protocol, the systems may be essentially the same. Thus, in systems described herein where a sending business is charged to send text messages, the business may be charged to send an email or other message. Similarly, where a followed non-profit, school or the like receives a contribution for each text message, the same entity may receive a contribution for emails or other messages. The costs or contributions may be the same for different message protocols; however, other embodiments contemplate different costs for different types of messages.

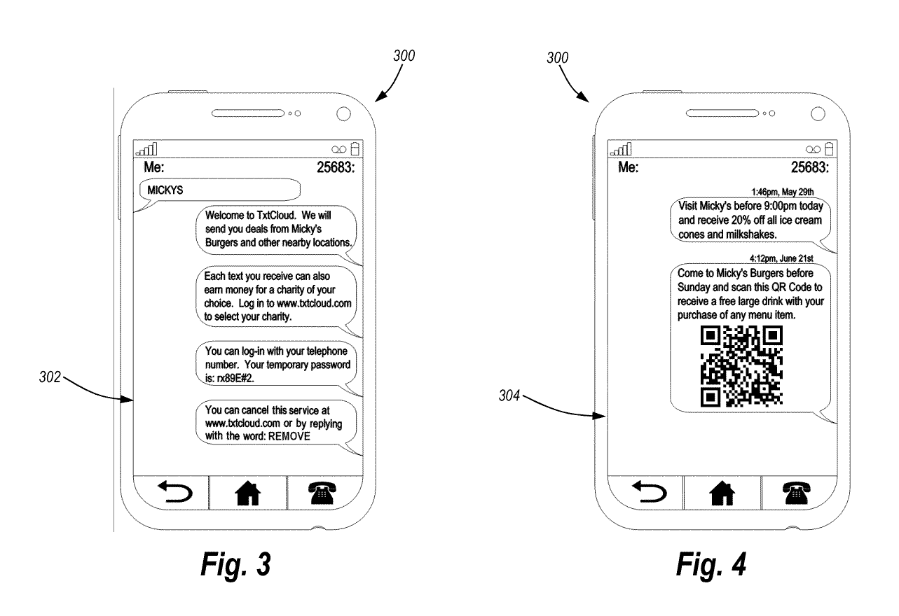

Now turning to FIGS. 3-19, an example mobile phone 300 is illustrated in some detail, and includes one or more applications that may provide various views based on the operations to be performed by a consumer or advertiser. Although the device is illustrated as a mobile phone 300, this is merely illustrative and could instead be other devices, including portable media devices, tablet computing devices, laptops, GPS devices, desktop computers, e-readers, and the like.

With respect to FIG. 3, the mobile phone 300 is shown as having a text messaging view 302 in which the consumer has sent a first message of “MICKYS” to the number 25683. According to some embodiments, the term “MICKYS” may be a short code used to opt-in to receipt of text message advertisements from an advertiser associated with the “MICKYS” short code and optionally for other retailers.

In some embodiments, a message distributor may act as a facilitator to both receive and distribute text messages. Accordingly, the “25683” number may be associated with the message distributor, and the message distributor may use the short code provided to associated the consumer's telephone number with a particular advertiser. By sending the short code to the message distributor, a registration process may optionally be started, and a consumer can be provided with an account to view and/or access his or her information. The account is, however, purely optional. Moreover, the consumer may have previously opted-in for advertisements from other advertisers that use the message distributor, in which case opting-in could be used to add information to the consumer's pre-existing account (e.g., by adding the consumer as a follower or customer of the new advertiser).

According to one embodiment, when a consumer opts-in or otherwise sends a text message using the text messaging system, the message distributor or a third party can send an acknowledgement. The acknowledgement may contain any suitable type of information. For instance, in FIG. 3, the acknowledgement includes information to welcome the consumer to the message distributor's service. The first acknowledgement may also indicate what the consumer has opted to receive (e.g., deals at Micky's Burgers and other nearby stores/locations). The same or other acknowledgements may also include other information, such as information about how to earn money for a charity, information on how to create or establish a login account, information on how to opt-out of future advertisements or how to cancel an account, and the like.

Once a consumer has opted-in, the consumer may be added to the advertiser's customer cloud and can begin to receive text message advertisements. FIG. 4 illustrates an example embodiment in which the consumer has received two text message advertisements as a result of its inclusion in the customer cloud for Micky's Burgers. A first advertisement provided a discount on certain products. A second advertisement may include information for free products. Of course, a variety of different products, services, advertisements, promotions, deals, and the like can be provided. Moreover, in addition to receipt of advertisements from Micky's Burgers, advertisements may be received for or from other retailers. For instance, where the user opted-in for nearby locations, advertisements from neighboring businesses could be received. Additionally, and as discussed herein, Micky's Burgers could potentially share its customer cloud with other advertisers, thereby allowing other advertisers to also send messages to the mobile phone 300.

FIG. 4 further illustrates a view 304 where a message could optionally include information to allow tracking of which users respond to advertisements. In particular, a message to the mobile phone 300 could include a code (e.g., the illustrated QR code). When the user wants to redeem the advertisement and obtain the promotion, the received code could be input, scanned, or otherwise received. A business may, for instance, use a handheld phone or other reading device to access the code and determine whether or not the code is valid. Optionally, redemption of the code can be reported to the messaging service or the like, as discussed in greater detail elsewhere herein. That code may be generated to be associated with the consumer using the electronic device 300. As a result, consumers that act on advertisements may be tracked, which could potentially allow advertisers and/or a message distributor to identify which customers are high priority customers and are most likely to respond to advertisements.

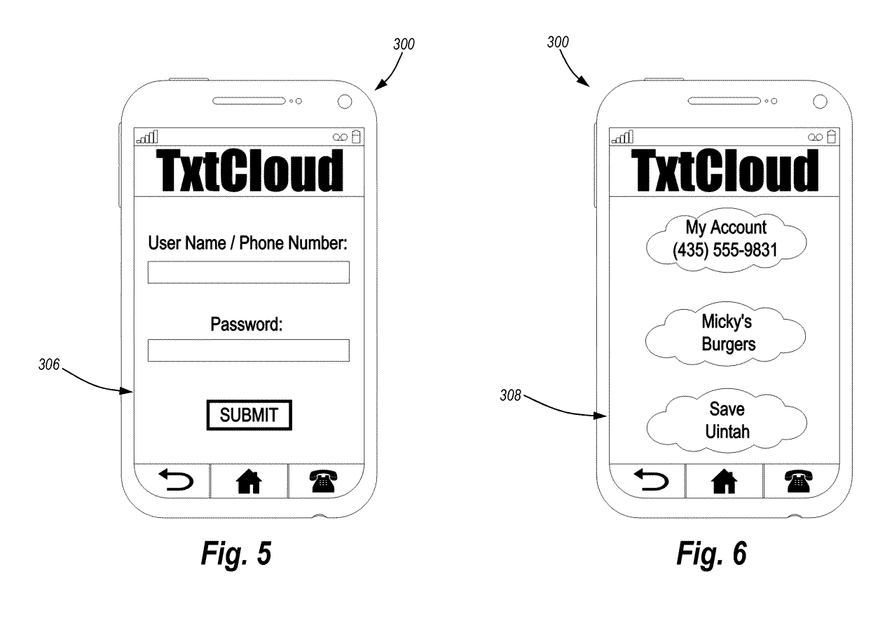

As discussed herein, a consumer, advertiser, charity or other entity could establish an account with the message distributor. FIG. 5 illustrates an example view 306 that may represent a login screen. In particular, a consumer could login to his or her account by entering a user name and password (or phone number and password). Of course, other login schemes and credentials could also be used.

Once logged in or otherwise authenticated or authorized by the message distributor, the mobile phone 300 can display a view 308 that allows the logged-in individual or entity to manage his or her account. In this embodiment, upon logging in the user is able to access three types of accounts. For instance, the user may be a consumer with a mobile phone registered for the service. In addition, the user may be authorized to use the “Micky's Burgers” account as an advertiser. In this embodiment, the user may also be authorized to use the “Save Uintah” account which may also be an advertiser account, and could be a business account, municipal account, charity account, or the like.

Although the illustrated embodiment depicts a single login by which a user of the mobile phone 300 may access each of multiple accounts, this is merely illustrative. In other embodiments, a user may be required to log-in separately to each of the different accounts. For simplicity, however, a single interface for accessing multiple accounts is shown.

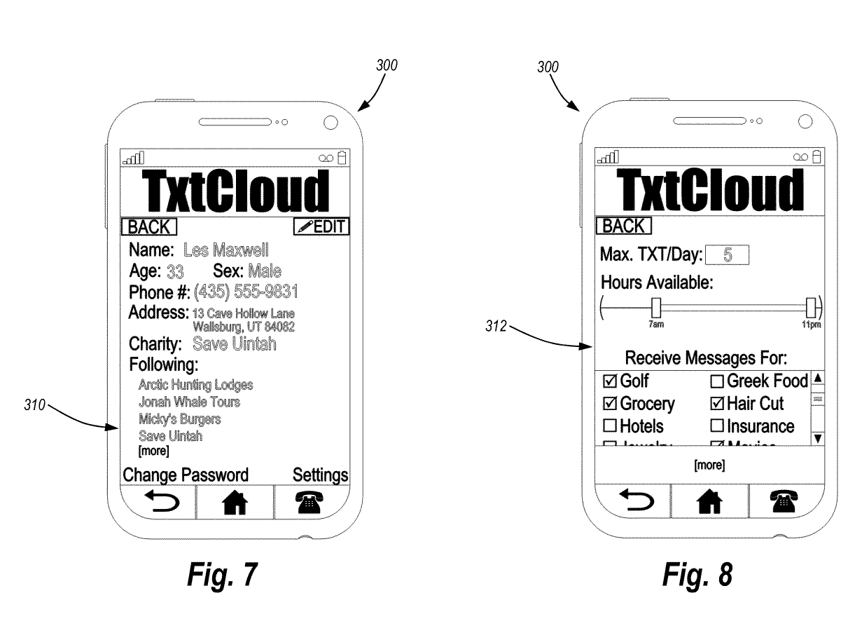

By accessing the option for the user's consumer account, the consumer could be directed to one or more views of the application running on the mobile phone 300, which views can allow a user to review his or her own information, his or her settings, preferences, and the like. FIGS. 7 and 8, for instance, illustrate example views 310, 312 of a consumer account where a user can view and/or edit his or her information and preferences.

In particular, FIG. 7 illustrates an example embodiment where the user can view his name, age, gender, contact information, and the like. Additional information may include an identification of which charity can receive contributions based on text messages the consumer receives. Still further information may include an identification of what advertisers the consumer is following or has supported. These advertisers may be selected by, for instance, sending a text message short code corresponding to the advertiser to the message distributor. Additionally, or alternatively, the consumer could search for or otherwise input advertisers directly through the view 310. An “EDIT” option in the view 310 could allow the user to change any or all of the displayed information. Further, a user could opt to change his or her account password or view his or her settings.

The settings option may provide a view 312 of one or more settings of the user's account, as shown in FIG. 8. The settings may correspond to the account settings (e.g., authorized users, passwords, etc.). In other embodiments, the settings may include text messaging settings. In FIG. 8, for instance, the consumer may set a maximum number of text messages to receive during a day, as well as the hours which the consumer is available. Optionally, if a text message is to be sent to the consumer, it could then only be sent during the time listed as available. If requested at a time when the consumer is not available, the message could be placed in a queue or otherwise delayed until the consumer is available, or the consumer may simply be eliminated as a candidate for a message.

The user may also set message limits in any number of different ways. For instance, a maximum number of messages may be specified over a day, week, month, etc. Additionally, or alternatively, a user can specify the number of messages to receive on an individual retailer basis. As an illustration, a user following “Save Uintah” and “Micky's Burgers” may allow two (2) messages a week from Micky's Burgers, but may allow five (5) messages a week from Save Uintah. Alternatively, the user can indicate a total number to be received across the entire system (e.g., five (5) messages a day regardless of the associated business). As discussed in greater detail hereafter, a business or charity may also share its cloud of users. In such an embodiment, messages sent by others with whom the cloud is shared may or may be subject to the same limits set for the particular business or charity. As an example, if Micky's Burgers shares its cloud with Al's Car Wash. Any text messages sent by Al's Car Wash may be subjected to the same limits the user specifies for Micky's Burgers. In other embodiments, shared messages may not be subjected to the same limits. How such limits apply may be programmatically or selectively configured. The messaging system can, for instance, directly specify how limits affect shared clouds; however, a user may also be able to specify limits and whether or not they affect messages from other companies with whom information is shared. A user could also potentially opt to allow or disallow any sharing of his or her information within shared clouds.

Also shown in the view 312 of FIG. 8, a user's settings or preferences could allow the user to select or deselect different types of products he or she would be interested in hearing more about. For instance, when a user opts-in to receive messages from a retailer and all nearby retailers, all of the categories may initially be specified. A user may, however, login and remove those in which he or she is not interested. Opt-out procedures may also allow a user to deselect particular retailers or categories by text message. Alternatively, the categories may initially be unchecked, and a user can expand his or her options by logging in or sending text messages to select particular categories. If a user has opted to receive messages from one or more sources (e.g., any nearby store or location), a text message distribution system may be able to account for the consumer's preferences in determining whether to send a message to the consumer. As an example, if a hotel near Micky's Burgers has a promotion, the promotion may not be sent to the consumer as “Hotels” has been deselected. In contrast, a nearby golf course may have its message routed to the consumer.

In addition to the settings and preferences of the view 312 of FIG. 8 and the personal information in the view 310 of FIG. 7, additional views and/or information may be provided or edited by the consumer. An additional view, for instance, may allow the consumer to see how much money the consumer's charity has received on his or her behalf. Additional information, including advertiser blacklists and the like could also be specified. Using the edit options, the consumer could of course also change his or her information, change what charity to support (or specify how to allocate a contribution among multiple charities), or otherwise add, edit or view information pertinent to the consumer's account. In addition, rather than displaying information in the views provided, additional views can be created to split information among different views, or views could be combined to display information in a single view.

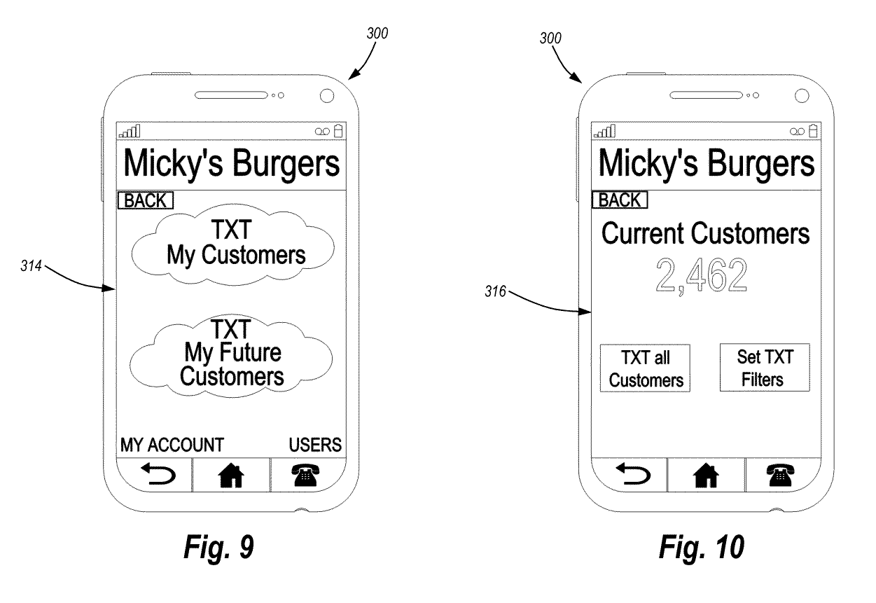

If, rather than selecting the consumer account option in the view 308 of FIG. 6 the user was to instead select the “Micky's Burgers” account option, the user could be directed to a view 314 as shown in FIG. 9. In this embodiment, the user may be authorized to use the Micky's Burgers account to send text message advertisements. For instance, in FIG. 9, the user may be authorized to select to send text messages to current customers or to future customers. In addition, the view 314 may allow the user to view the Micky's Burgers account information and/or information on authorized users of the account.

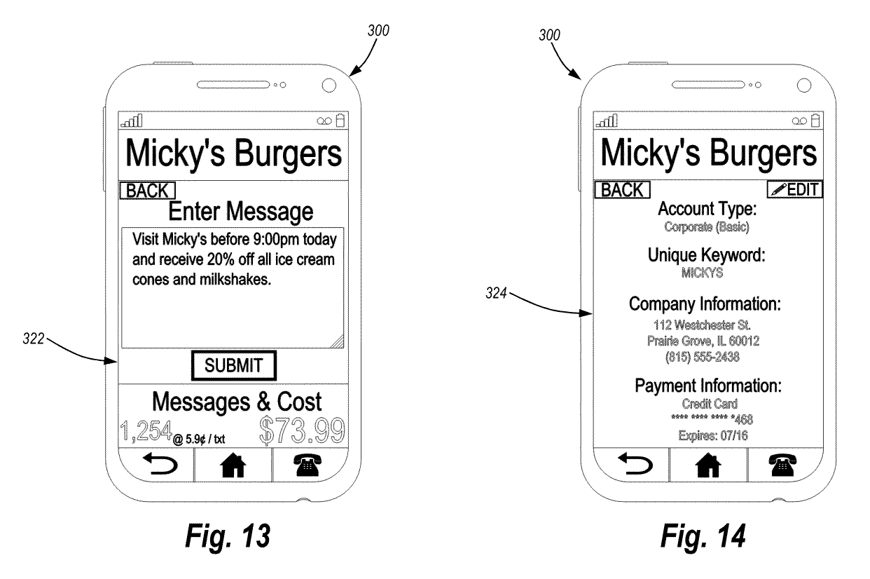

In one embodiment, the current customers identified with the advertiser may include those consumers that have specifically requested advertisements for the advertiser. This may include consumers who have sent a required short code or keyword to the message distributor. The consumers may also include consumers who have used their consumer account to follow or support the advertiser, even if not specifically submitting the short code or keyword via text message. If the user selects the option to send text messages to current customers, messages may then be sent to those in the customer cloud. Optionally, prior to submitting a message, a view 316 may allow the user to see how many people are in the customer cloud, as shown in FIG. 10. From the provided view, the user could then send a text message to all those customers (i.e., to all 2,462), or the user could limit who receives the text message. Filtering users and sending messages is described in greater detail with respect to FIGS. 12 and 13.

Rather than limiting promotional or advertising messages to only those customers currently supporting the advertiser, the advertiser may elect to expand his or her advertising base. Returning briefly to FIG. 9, a user may do so by electing an option to text non-supporters (i.e., those who may become future customers). By selecting to send text messages to non-customers, the advertiser could expand his or her customer base and try and develop new loyal customers and followers.

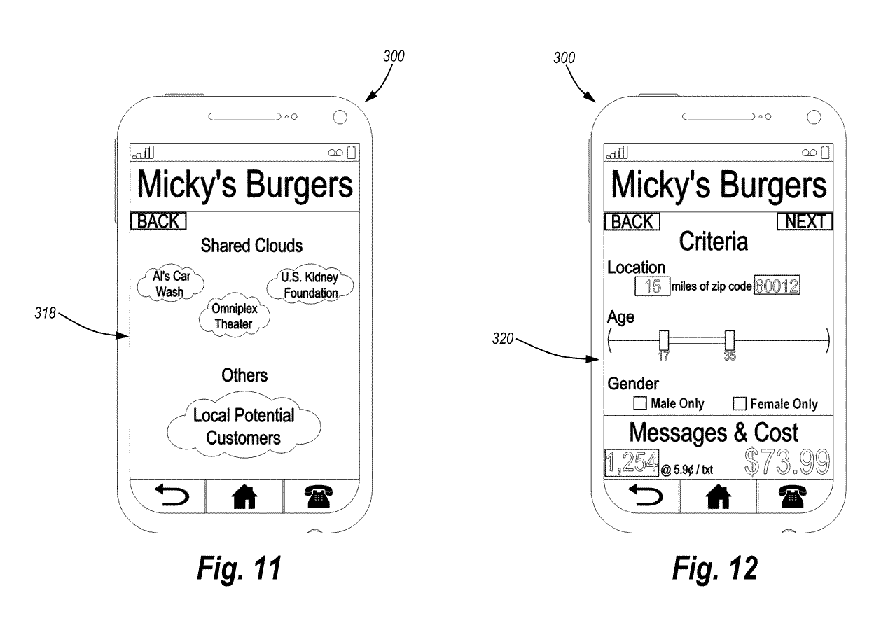

FIG. 11 illustrates an example view 318 that may be displayed by the mobile phone 300. In some embodiments, there may be still further optional, additional customer clouds from which to select. In FIG. 11, for instance, the user may be able to select “Local Potential Customers” which may correspond to non-followers who have opted-in with nearby companies that also use the message distributor's services. In still other embodiments, different advertisers may share their respective customer clouds with another advertiser. As discussed herein, shared customer clouds may be used to send text messages, although user preferences and limits may still be respected and used based on the cloud. Such preferences and limits may be evaluated based on the advertiser being different than the advertiser sharing the cloud, although in some cases, such preferences or limits are evaluated as if the advertiser is the same entity as the one sharing the cloud.

More particularly, FIG. 11 illustrates an example where three additional advertisers (two businesses and one charity) have granted Micky's Burgers authorization to text message their customer base. Each advertiser could optionally grant or restrict such access, and could require a password be entered, or a request be submitted and then authorized prior to granting of the request to share customer clouds.

Advertisers may share customer clouds for a number of different reasons. For instance, in one embodiment, two entities may be running a cross-promotion. Take, for instance, the example of a charitable organization. They may have an arrangement with Micky's Burgers so that a portion of all purchases made at Micky's Burgers are donated to the charity. The charity may therefore grant Micky's Burgers access to its customer cloud to get those supportive of the charity involved. Similarly, other businesses may also run cross-promotions or other deals where granting another access to its customer cloud could be helpful.

In another aspect, some companies may run a franchise system. In one embodiment, all franchises could be set-up as users to access an overall customer cloud for the entire franchise system. The franchise may be a national brand and, as a result, the national company could send out national advertisements from time-to-time. If the franchise had a promotion, the franchise could use its access as an authorized user to send out information (optionally by restricting the geographic area as appropriate). As an authorized user, payment associated with sending the text messages could be made by the corporate headquarters. In contrast, if the national cloud is shared (as opposed to making the user an authorized user of the national account), payment for texts may be made by the user, not the advertiser sharing the cloud. Of course, the system may be set-up in other ways as well.

There may be various reasons for sending text messages to current customers (see FIG. 10) as the main account or as an authorized user of the main account, or to consumers within shard clouds of other advertisers, rather than to a general cloud. For instance, by contacting those who are already known to be supportive of a company or cause, an advertiser can reach the most fervent customers and obtain a greater response. Additionally, there may also be cost differences based on which cloud is used.

As an illustration, an advertiser sending messages to its own customer cloud may send the messages at one rate. If, however, the customer sends a message generally to non-customers that are nearby, there may be a higher rate. For instance, text messages to current customers may be between about $0.005 and about $0.035 while text messages to potential customers may be between about $0.035 to about $0.075 per message. Of course, these rates are merely illustrative and could be higher or lower. Such variation may be occur due to fixed pricing, or may be the result of discounts available to certain classes of customers (e.g., preferred vs. basic, high-volume vs. low-volume, etc.)

The rates to a shared cloud could also vary. In one embodiment, an advertiser may send text messages to consumers of a shared customer cloud at the same rate as the sharing advertiser. In other words, if the advertiser sharing its cloud has a rate of $0.029 per text message, an advertiser receiving shared access to the cloud may obtain the same rate. In the same or other embodiments, however, the rate may be higher or lower than the rate the advertiser pays for his or her own customers (i.e., the consumers in its own cloud as opposed to a shared cloud).

Regardless of whether the user decides to send text messages to its own customer cloud, to a shared cloud, or to a general cloud, the user could be given the option to filter the results. This option may be particularly desired where, for instance, there is a large pool of candidate recipients and it would be too expensive or inefficient to send messages to everyone. FIG. 12 illustrates an example view 320 of an application that allows different options for filtering who receives the text messages. FIG. 12 is, however, but one example of how message recipients may be filtered, and any number of different views, filters, criteria, and the like may be used to limit or control how messages are distributed and/or to whom they are sent.

More particularly, FIG. 12 illustrates one example in which a user may be given the option to filter text messages based on myriad criteria. In one example, location may be used. For instance, the user may be able to specify an area (e.g., by zip code) and a proximity to that area (e.g., anything within a 15 mile radius of the area). Either or both the area and range may be variable. As will be appreciated, by reducing the proximity, the number of potential customers can be reduced.

Additionally, where demographic information about consumers is available, the demographic information may be considered. In FIG. 12, for instance, the user may specify to target consumers between the ages of 17 and 35. This range may be set-up inclusively or exclusively. That is to say, in one embodiment, anyone found to have an age of 17-35 may be a candidate for a text message. In another embodiment, however, anyone found to have an age of 0-17 or 36+ may be excluded. The set-up may have implications where, for instance, a consumer does not provide age information. Under the inclusive scenario, a consumer without age information would not receive the text message; however, under the exclusive scenario, a consumer could receive a text message.

Additionally, gender or other criteria may also be specified as a filter. In the illustrated embodiment, the filter is set to allow messages to be sent only to men, or only to women. In this particular embodiment, neither the men or women only options are selected, so the filter may be disabled and messages may be sent to recipients without respect to their gender. In other embodiments, different filters for gender or other criteria may be used. For instance, the genders of recipients may be filtered in a proportional fashion (e.g., to send 35% of all messages to males and 65% to females). Of course, any range or proportion (including 100% male or 100% female) could be specified. Indeed, the options provided in FIG. 12 would allow 100% male or 100% female options to be selected. Where a proportion is set, the user may also set a maximum number of messages to send. The maximum may be less than a total of available candidates so that the message distribution system can select which of the available recipients is to receive the messages.

Age, gender, location and maximum messages are only some of the types of filters that may be applied. In other embodiments, for instance, income level, education level, types of interests, or other criteria may be specified to filter who may be a candidate to receive a text message. In still another embodiment, only candidates over a threshold likelihood of responding to the advertisement may be selected. Some filters may be included solely to limit the pool of available consumers, while other filters may be available to limit the pool of available consumers but may also carry an additional cost.

As also shown in FIG. 12, the view 320 may optionally indicate how may text messages are to be sent and/or the cost to the advertiser in sending those messages. In this embodiment, for instance, there are 1,254 available candidates and, at $0.059 per text message, the advertiser would have a cost of $73.99 to send the messages. The total messages could be based on the filters as set, on a maximum number of text messages to send, or any other filter as set. Moreover, the rate may be based on the type of message sent (e.g., to the advertiser's own customer cloud, to a shared cloud, to a general cloud, etc.). Information related to the total number of text messages to be sent and/or the cost, may be optionally displayed in real time, or may be provided after a request is submitted to the message distributor. Additionally, rather than basing the text messages strictly on the filters that are applied, the user may also directly specify a number of text messages to send. The number may be an exact number or a maximum number. Thus, while the 1,254 recipients identified in FIG. 12 may correspond to available candidates based on set filters, the number 1,254 could instead be a number directly input into the view 320. The number identified may also be provided based on filters, and then overridden (or a separate field or preference may be provided to set an exact or maximum number of filters to apply).

At some point, whether before or after selecting criteria for the recipients of a text message (or at some point in between), the content of the text message may be specified. An example is provided in the view 322 of FIG. 13 in which a message relating to discounts is provided in a text input pane. Once the desired text has been input, the user can submit the text to the message distributor, who can then send the text message to identified recipients. As discussed above, the user may have control over a number of text messages to send. Such control may be exercised using filters or selection criteria (see FIG. 13), or in other manners. For instance, rather than specifying an exact or maximum number of text messages to send in the view 320 of FIG. 12, the user could set a maximum or exact number of messages to send in the view 322 of FIG. 13. Optionally, the message may include an optional tracking code or information (see FIG. 4). In some embodiments, the message distributor can generate the tracking codes, and optionally does so at an additional cost to the advertiser. Although not necessary, the view where a message is finally submitted, or a view where an order for a text message is submitted, an indication of the total cost and/or number of text messages to be sent can be provided.

As discussed herein, in addition to sending text messages, a dedicated or general-purpose application on the mobile phone 300 may be used to also provide and/or edit information about the advertiser. An example view 324 is illustrated in FIG. 14 and includes information about the advertiser, including the type of account maintained by the advertiser, the unique keyword (or short code) corresponding to the advertiser, and contact information and financial information for the advertiser. The financial information is optionally stored and includes information that can be used to charge the advertiser for text messages sent using the message distribution system. If desired, the user can edit such information at any time.

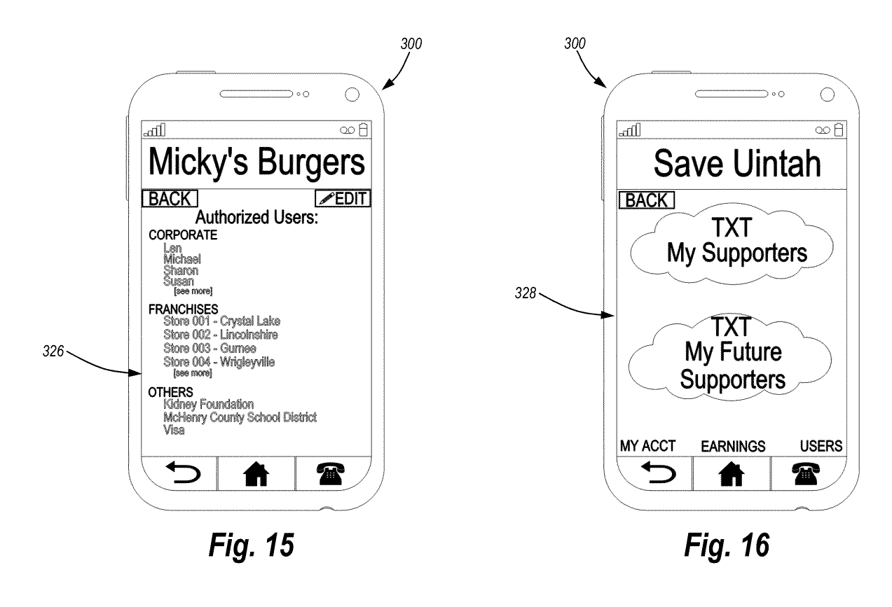

The mobile phone 300 may also allow an advertiser to view who might have access to the account. In FIG. 15, for instance, the mobile phone 300 includes a view 326 in which consumers or advertisers who can access the account and make changes thereto, send text messages therewith, or otherwise use the account are displayed. In this particular embodiment, four corporate users are shown, along with four franchisees and three other users. As will be appreciated in view of the disclosure herein, users may be given full access to an account, or may be given limited access. For instance, upon being approved as a user, certain access restrictions and permissions may be included on any account. As an example, some account users may be limited in the number or frequency in which they can send text messages, the locations where they can send text messages, the scope of access to view or change account or advertiser information, and the like. Some users, rather than being users, may instead be other users or advertisers with whom a cloud is shared. For instance, the three “Other” users may have access to use a cloud, but no more. Payment options may also be restricted. As an illustration, the corporate users may be authorized to pay for text messages using the advertiser's corporate account, whereas franchisees and/or others may be required to pay for text messages using their own accounts.

Returning briefly to FIG. 6, it will be appreciated that in some embodiments, a user may login to an account and have access to a charity account. A charity account may generally include accounts that can be used for fundraising purposes in addition to, or instead of, sending text messages. Charity accounts may correspond to schools, churches, civic organizations, municipalities, non-profits, and other organizations that may use text messaging for fundraising.

If the user accesses the Save Uintah account, the user can be directed to a view 328 as shown in FIG. 16, in which view 328 the user can send text messages to current supporters as well as future supporters. For the sake of simplicity, it is noted that sending messages to supporters and future supporters of a charity may act in a manner similar to that for a business that is an advertiser. As an illustration, a consumer can send a text message with a keyword corresponding to the charity to a number, and that consumer can be added to the charity's supporter cloud. Other people who may have opted-in for additional messages, but who have not specifically identified the particular charity, may be available as future supporters. A charity may send text messages similar to any other user, although in some embodiments a charity may be given a discount on per text message pricing.

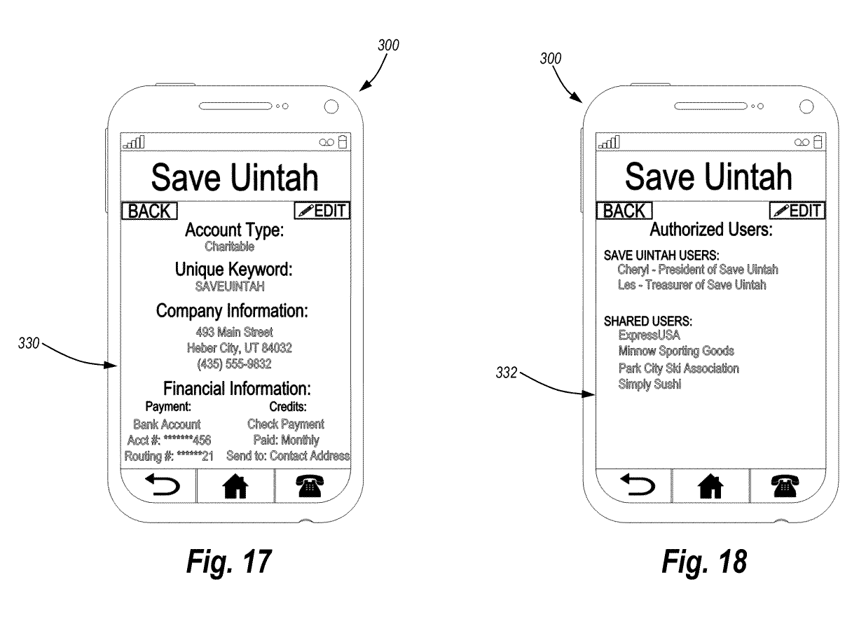

When the user accesses the charity's account information, the user may be directed to a view similar to the view 330 in FIG. 17. In this embodiment, the account type, unique keyword, and company information is provided. As the charity may send text messages, payment information can also be provided. As discussed herein, some charities may also receive donations, credits or other compensation from the message distribution system. For instance, consumers who create accounts may become supporters of charities. One or more of the supported charities can be identified as one to which the customer would contribute. Thereafter, any text messages the consumer receives may have a portion of the price donated to the charity identified for contributions.

How the charity receives payments can be varied as desired. In FIG. 17, for instance, the charity is shown as receiving a check payment on a monthly basis. In other embodiments, however, credits may be applied towards text messaging. Monetary, direct deposit payments could also be applied. Additionally, rather than accounting on a monthly basis, the credits or payments could be applied on other terms, including daily, weekly, yearly, or even in near real-time once payment is received.

A charity may, in addition to viewing the account information, also view and set-up users who are authorized to act on behalf of the charity, and users who can use the charity's supporter cloud. FIG. 18, for instance, illustrates a mobile phone 300 with a view where authorized users and shared users are identified. As discussed herein, authorized users may be those authorized to act on behalf of the charity, and may have one set of permissions. For instance, users may be given access to change company information, send text messages, make payments, and the like. In contrast, shared users may be granted access to the charity's supporter cloud, but may otherwise have limited rights. As an illustration, a shared user can send messages to the consumers in the charity's consumer cloud, but may be required to make payment on its own. A shared user may also not be able to access or change charity information, user permissions, and the like.

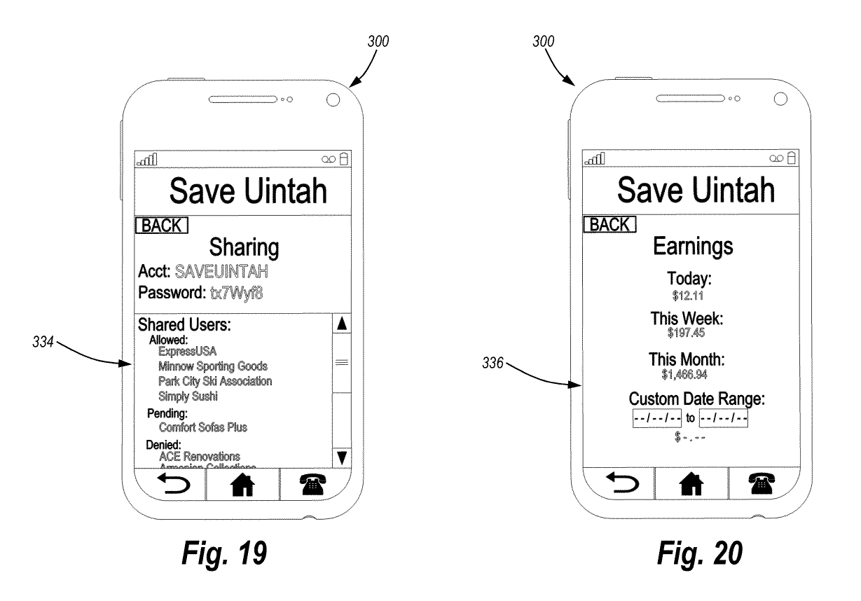

One or more users (or the main account user) may be set-up with administrator-type access to have full access to the charity. In some embodiments, administrative level users can specify who has access as a user (as well as what permissions to apply) and who has access to a shared cloud. FIG. 19, for instance, illustrates a view 334 that may be available to see shared users in greater detail. In this embodiment, the account keyword is illustrated, along with a password. In some embodiments, a user wishing to access the shared cloud may be required to input the password. According to at least one embodiment, the password may be entered into a view of the application on the mobile phone 300, although in other embodiments a user may request access by text message. For instance, by sending a text message with the keyword and password, access as a shared user could automatically be granted.

An administrator of the account may also be able to grant or deny access to shared users. The view 334 illustrates, for instance, that some users or advertisers may be allowed to share the supporter cloud, while others may have their privileges denied or revoked. Others may have requested access, but approval is still pending.

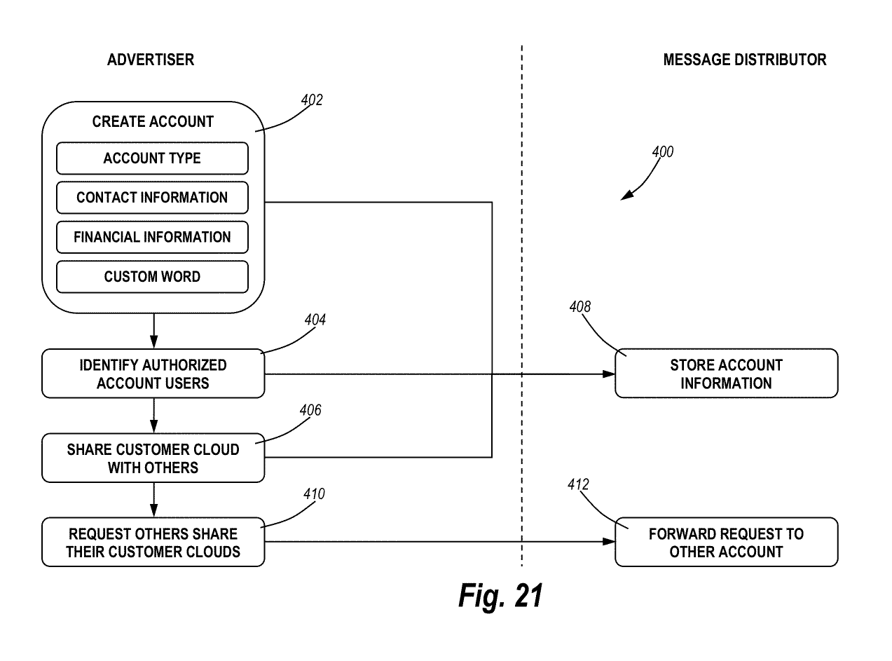

Charitable organizations using the systems and methods disclosed herein may be able to use text messaging to raise funds and/or send text messages. FIG. 16, for instance, illustrates where a user can send text messages or access a statement of what rewards, earnings or other compensation the charity has received. FIG. 20 further illustrates an example view 336 where earnings are described.

In particular, when a consumer receives a text message, a portion of the cost to send that text message may be allocated to a charity. As a charity accumulates contributors, text messages sent to those contributors can accumulate to potentially raise large funds for the charity. Whatever funds are allocated to the charity may be tracked using the view 336 or another suitable view. In this embodiment, the view 336 shows daily, weekly, and monthly rewards. Additionally, an option is provided to view rewards over a custom period; however, any desired type of view or options for displaying rewards or earnings can be provided.

While FIGS. 3-20 illustrate example views on a mobile phone 300, it should be appreciated that such embodiments are merely illustrative. In other embodiments, for instance, the information may be available over the Internet through an account that can be accessed from any number of different types of computing devices. Thus, a user with a consumer or advertiser account (business and/or charity) could access account information, submit text messages to be sent, and the like at any time and from virtually any location.

Methods of the present disclosure may be generally be understood in the context of the disclosure above, including the embodiments of systems as disclosed herein. Nevertheless, to illustrate some example manners in which methods may be used, FIGS. 21-25 further illustrate example methods within the scope of the present disclosure, including methods for creating advertiser and consumer accounts, distributing text message advertisements, rewarding charities, and tracking advertisement redemption. While the methods of FIGS. 21-25 are shown separately, they may run in parallel or sequentially, and can thus contribute to a single method, or multiple sub-processes and methods.

In FIG. 21, a user may create an account as shown in step 402. The account that is created may be for an entity that intends to send text messages, such as an advertiser. Upon creating the account, the user can specify different types of information. Information that may be included includes the type of account (e.g., basic or premium, business or charity, etc.). Contact information for the advertiser may also be included, along with financial information. Contact information may include address and telephone information, or other contact information. Financial information can include, by way of illustration, information to pay for text messages that are received and/or information on where or how payment can be received, particularly in the case of a charity, but also for a business in the case of credits or refunds. The advertiser may also create a custom word. The custom word may be a keyword that is used to identify the advertiser when consumers opt-in to receive text messages. The message distributor may be an accumulator for multiple advertisers, so the custom word may serve to distinguish the advertiser from other advertisers.

Any or all of the account information may be changed or varied based on the type of account a user has with the provider. For instance, a higher level account may be able to enter or customize their information more than a lower level account. Similarly, the custom word may be available to some types of accounts but not others, or may satisfy different characteristics for different accounts. As an example, a higher level account may have the ability to use a shorter or easier to remember custom word, while a lower level account may be limited as to the types of custom words that can be used. In other embodiments, a specific fee may be charged for the custom word separate from or in addition to fees associated with an account or account transactions.

When the account is created, the advertiser may also identify users of the text messaging system who are authorized on the account, as shown in act 404. Such users may be individuals or may be entities. Furthermore, identifying the users may include setting permissions for the users.

The customer/supporter cloud for the advertiser may be used by the advertiser to send text messages to its loyal customers and supporters. In some cases, the advertiser may wish to share its cloud with other entities. In such a case, the advertiser may also specify what individuals or entities are granted shared access to the cloud. At any time, any of the information on the account may also be stored by the message distributor as account information. Also stored as account information may be information about the cloud of the advertiser, including identifications of the consumers who are customers or supporters. In some cases, the advertiser may know some or all of the customers or supporters, or a number of customers or supporters; however, the identities of those customers or supporters may not be provided to the advertiser in other embodiments where the message distributor acts as a facilitator in receiving and/or sending text messages.

While the advertiser may share its cloud with others, the advertiser may also request that others share their clouds. Thus, in act 410, the advertiser makes a request to one or more others to share their customer clouds. This may be done by sending a message through a message distribution management system. In other embodiments, a text message may be sent (e.g., with a keyword and password), to request access. Regardless of how requested, the message distributor can forward the request to the other account where shared access is requested (act 412).

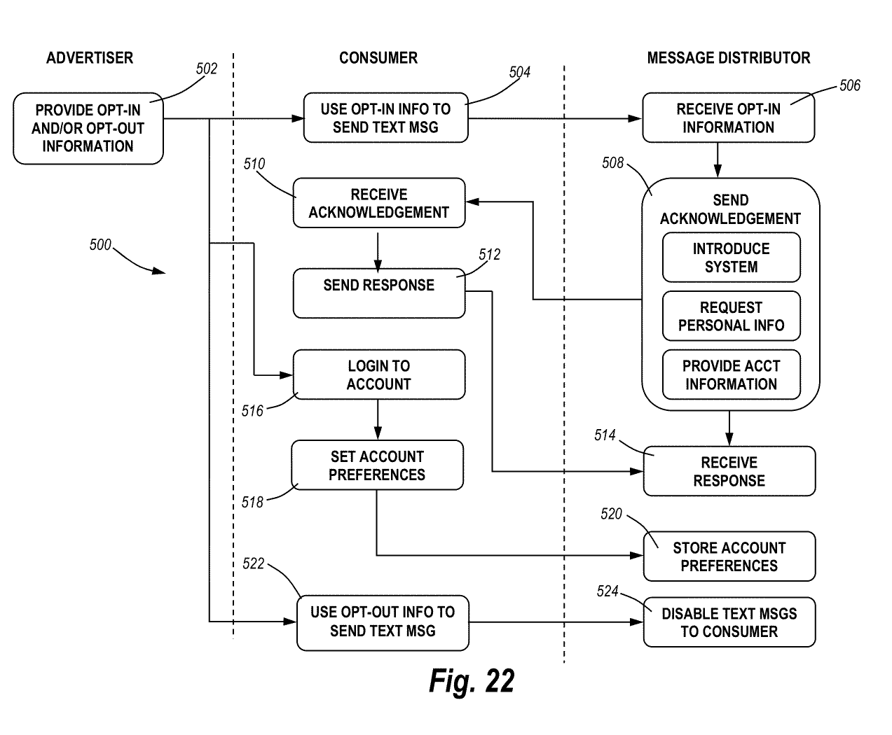

When an advertiser's account is created, the advertiser may use the account to begin subscribing customers to its cloud of customers or supporters. FIG. 22 illustrates an example method 500 in which this may be done. For instance, the advertiser may provide opt-in information to customers or supporters. An example method for doing so is to display a sign providing the custom word for the advertiser's account, along with the number (or location) where a text message including the custom word can be sent. The consumer may use this information in act 504 to send the text message, and the text message can be received in act 506 by the message distributor. Once the information is received, the message distributor may send an acknowledgement to the consumer in act 508. The acknowledgment can include any number of different types of information, and can include one or more messages. Some information that can be included in the acknowledgement is a welcome and/or introduction to the system managed by the message distributor. The consumer's personal information may also be requested and/or account information can be provided. Account information may correspond to the user's personal account, which can optionally be created automatically when the consumer opts-in to the message distribution system for the first time. Of course, if the consumer opts in for an advertiser and is already a user of the system, the acknowledgement may be sent but may contain additional, different, or less information. Other information that may be in the acknowledgement includes description of charitable giving functions of the system.

The consumer may receive the acknowledgment in act 510, and can then send a response in act 512. The response can potentially include some of the requested personal information (e.g., age, gender, location, etc.), or can include any other information (e.g., a request for removal if the consumer erroneously opted-in). The response can be received by the message distributor 514, and can include saving, storing or changing account information based on the response.

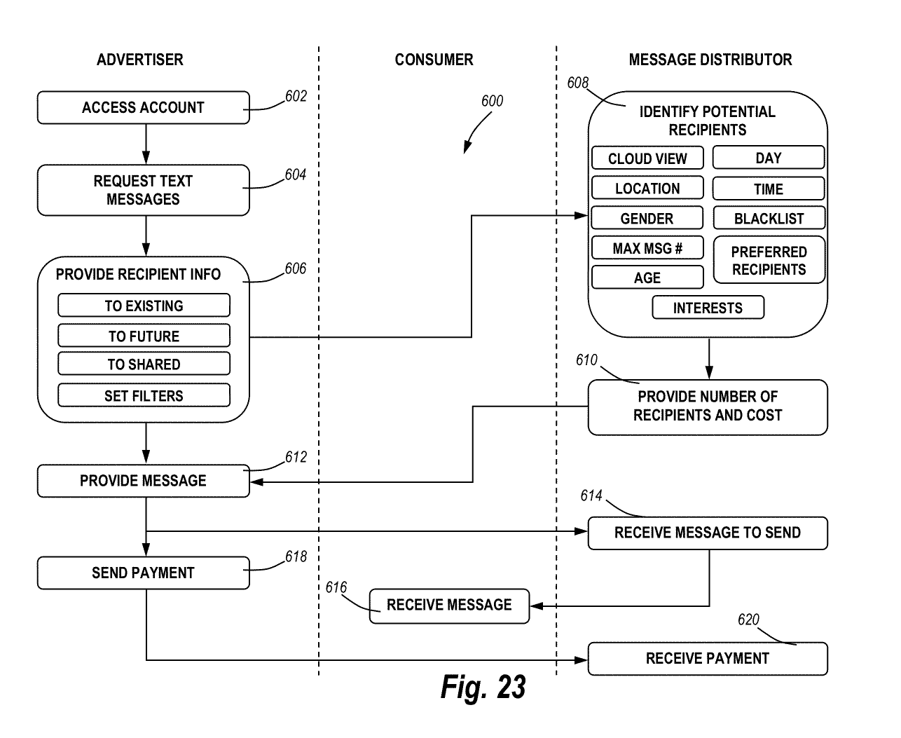

A user may also log-in to his or her account in act 516. In the account, the user can set his or her preferences in act 518. Any of a number of different preferences can be set. Such preferences may include text message preferences such as: maximum number; hours of receipt; topics of interest; advertisers of interest; blacklisted advertisers; and the like. Setting account preferences can also include selecting a charity to contribute to (or multiple charities and a potential allocation scheme). In some embodiments, a consumer may be in the supporter cloud of multiple charities, but contributions on the consumer's behalf may be limited to a single charity (or less than all the supported charities). In other embodiments, the contribution charity may not be one where the user is in the supporter cloud thereof. Account preferences and information may be stored by the message distributor 520. Optionally, information about the consumers as stored in user accounts (or as attached to clouds for advertisers) may be used in the method 600 of FIG. 23.

As discussed herein, embodiments of the present disclosure may relate to sending text messages to consumers who opt in for a particular service. At some point, some consumers may no longer wish to receive text messages. In such a case, a user may use opt-out information provided by the advertiser in act 502, or as otherwise obtained. In FIG. 22, for instance, the opt-out information can be used in a text message sent by the consumer in act 522. The received opt-out information may then be received by the message distributor to disable text messaging services to the consumer as shown in act 524.

Now referring to FIG. 23, an advertiser may access its associated account as shown in act 602. Using the account, the advertiser may request text messages be sent (act 604). Such a request may include providing information on the desired recipients (act 606). For instance, an advertiser may choose to send text messages to its current customers or supporters. Alternatively, a message may be sent to non-customers and non-supporters to try and make them future supporters and customers. Some advertisers may also have access to shared clouds of other advertisers and the ability to send text messages to members of that cloud. As discussed herein, when any pool of recipients is selected, filters may also be set to limit who or how many people receive the text messages.

When the recipient information is provided, it can be directed to the message distributor who then identifies potential recipients in act 608. Identifying the recipients can include looking at the appropriate cloud or location of the recipients in relation to the selections and/or filters selected by the advertiser in act 606. Identifying the recipients can further include considering additional information, including the gender of the recipient, the maximum number of messages to be sent by a receiver and/or to be received by a consumer, the age of a consumer, the consumer's interests, the day and/or time when a message is to be sent, whether the advertiser is on a blacklist for a consumer, and the like. According to at least one embodiment, identifying recipients may also include identifying preferred recipients. A preferred recipient may, for instance, be a recipient meeting stricter filter criteria. For instance, an advertiser may set multiple filter sets. If one filter set does not create a maximum number of text messages, a lesser filter set may be applied. In some cases, preferred recipients may include those who are associated with a higher relative likelihood of acting on an advertisement or other message received from the advertiser through the message distributor.

The number of potential recipients and the relative cost to send text messages to those recipients may be provided by the message distributor to the advertiser; however, in some embodiments the cost may be determined by the advertiser 612. If the number or cost is too high or low, the advertiser may repeat act 606 until the desired parameters are set.

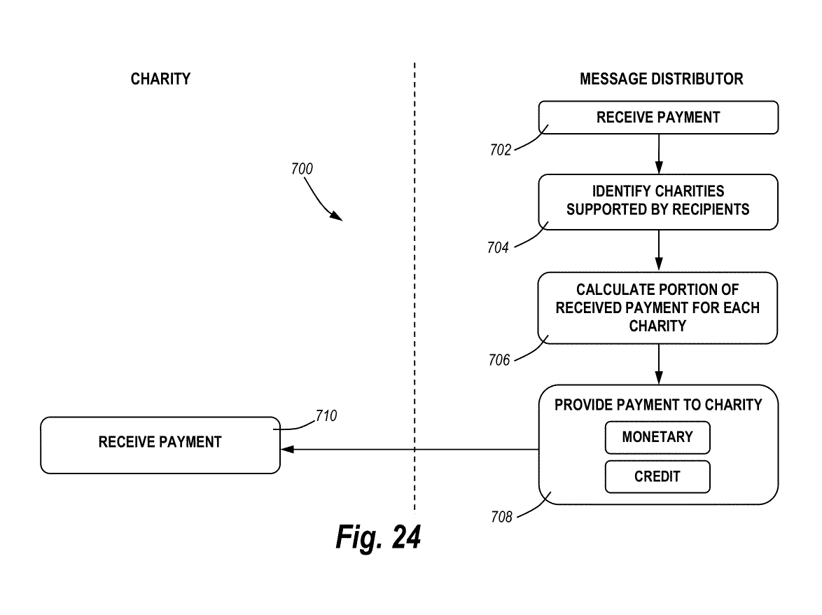

The advertiser may also provide a message in act 612, which act may be performed at any time, including before providing recipient information in act 606. The provided message can be sent to the message distributor who receives the message (act 614) and sends the message to consumers previously identified in act 608. The consumers then receive the message in act 616.

Where the advertiser pays to have the text messages sent, payment may be calculated and sent in act 618, and ultimately received by the message distributor in act 620. Once payment is received, some embodiments of the present disclosure contemplate allocating portions of the payment to different charitable organizations or other recipients. In the method 700 of FIG. 24, for instance, payment is received in act 702. Thereafter, charities supported by recipient consumers may be identified in act 704. Identifying the charities may include reviewing the recipients of a message (see act 608 of FIG. 23). If the recipients have identified a charity they prefer to receive contributions based on their received text messages, the portions of payments for text messages can be calculated for each charity in the pool of recipient consumers (act 706). Payment may then be provided to each charity in act 708 in any desired manner. The payment may be monetary or in the form of a credit (e.g., a credit towards sending text messages), or may occur in other manners. Payment received in whatever manner may be received in act 710 by the charity, where it can then be spent or otherwise put to use.

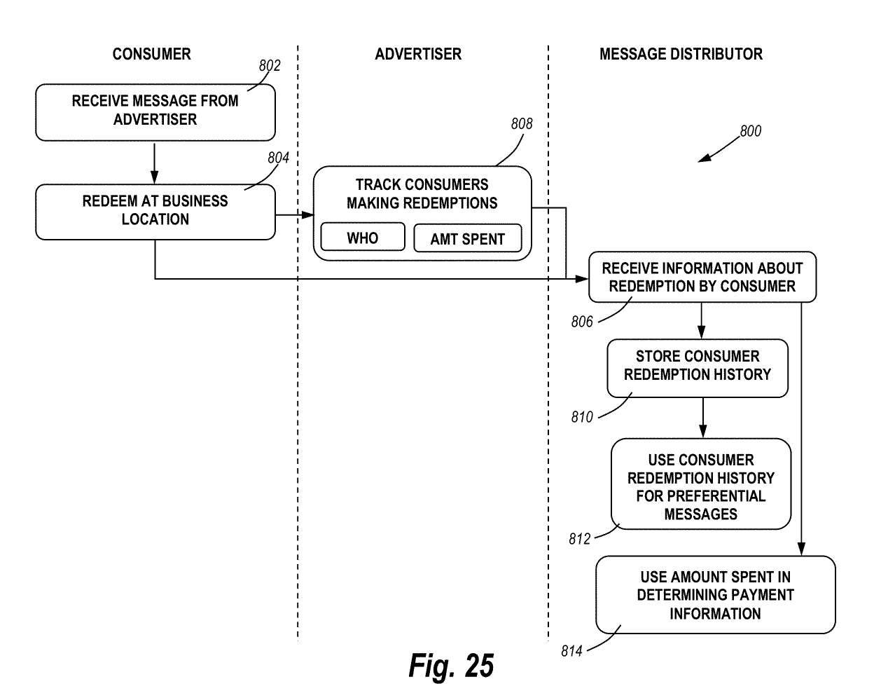

As noted herein, some embodiments contemplate tracking response of consumers to advertisements. An example method 800 for such tracking is shown in FIG. 25. In the illustrated figure, a consumer can receive a message from an advertiser (act 802). If the consumer is interested in the message—which message may be an advertisement, coupon, promotion, or the like—the consumer can redeem the message at a corresponding business location for the advertiser (act 804). Optionally, when redemption occurs, the message distributor receives information about the redemption by the consumer (act 806). This may occur in any of a number of manners. For instance, a consumer may redeem a promotion using a code, and redemption of the code can be sent to the message distributor. The message distributor can correlate the code with the consumer. In other embodiments, the consumer may send a message to the message distributor indicating that redemption was made (e.g., a text message with a keyword, dollar spent, date, time, transaction number, or the like). The message distributor could also validate such information with an advertiser.

In other embodiments, an advertiser may track users who make redemptions (act 808). For instance, each customer who responds to an advertisement may be requested to identify who they are, how much they spent, and the like. Such information can optionally be sent to the message distributor, or maintained by the advertiser. In some embodiments, the information can be used to determine a payment to send to a third party (e.g., in a shared cloud, a portion of all money received may go to advertiser sharing the cloud).

Consumers that respond to advertisements may be tracked. For instance, a consumer redemption history may be stored (act 810). Such a redemption history may allow the message distributor to identify consumers who more regularly respond to advertisements. For such high-response consumers, the redemption history can be used to identify them as recipients for preferential messages (act 812). In particular, advertisers may be willing to pay a premium for those consumers who will not only receive a message but who have a higher relative chance of responding. As noted above and shown in act 814, the amount a user spends may also be used in determining payment information. Payment information may include how much to pay to a charity, to an advertiser sharing a cloud, or the like.

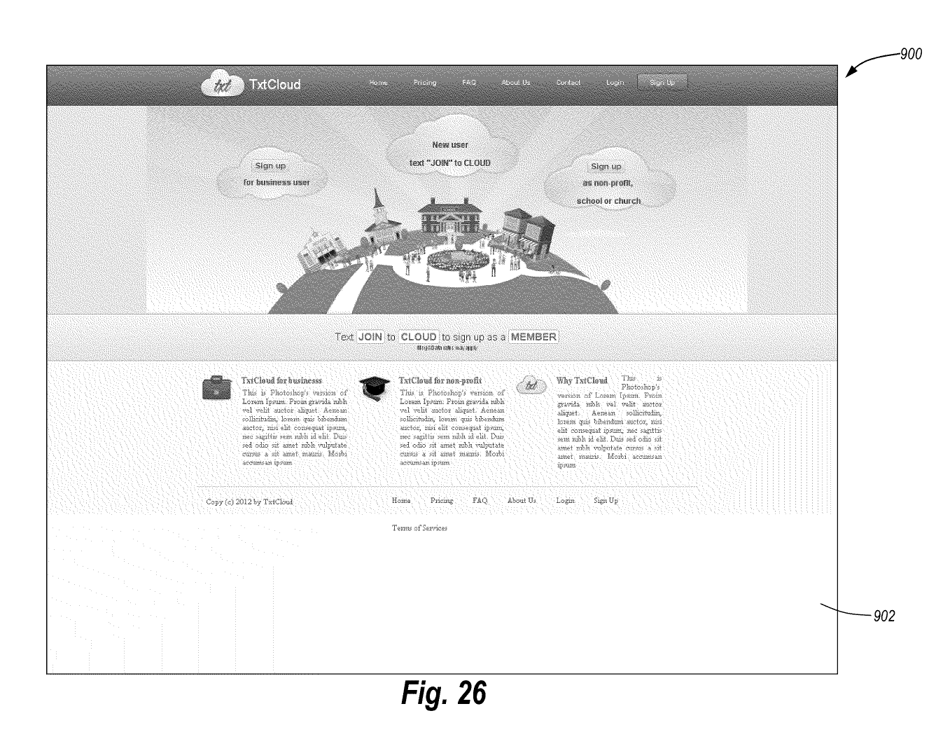

Turning now to FIGS. 26-37, various views of an example interface 900 usable in connection with embodiments of the present disclosure is provided. It should be appreciated that the illustrated interface 900, and the corresponding views 902-926, are merely illustrative and are not intended to limit the scope of the present disclosure to any particular set of interfaces or views, or any particular functionality.

With respect to FIG. 26, an example home page view 902 is displayed, and includes various options that may be selected by an entity or person accessing the page. In this embodiment, for instance, a business, non-profit or other similar user may sign-up for services, view pricing information, view information about the system, and the like. A user may also obtain information for sending a text message to join as a consumer.

Through the sign-up process, the user may provide his or her personal information and/or the information of a company, non-profit or other entity that the person represents. For instance, a person may provide his or her own contact information (e.g., phone number, email address, address, etc.) and/or the name and contact information of an associated entity. Billing information (e.g., credit card, account information, etc.) may also be provided for to allow payment for services provided. Of course, other information may additionally or alternatively be provided, including selection of login credentials (e.g., user name and password).

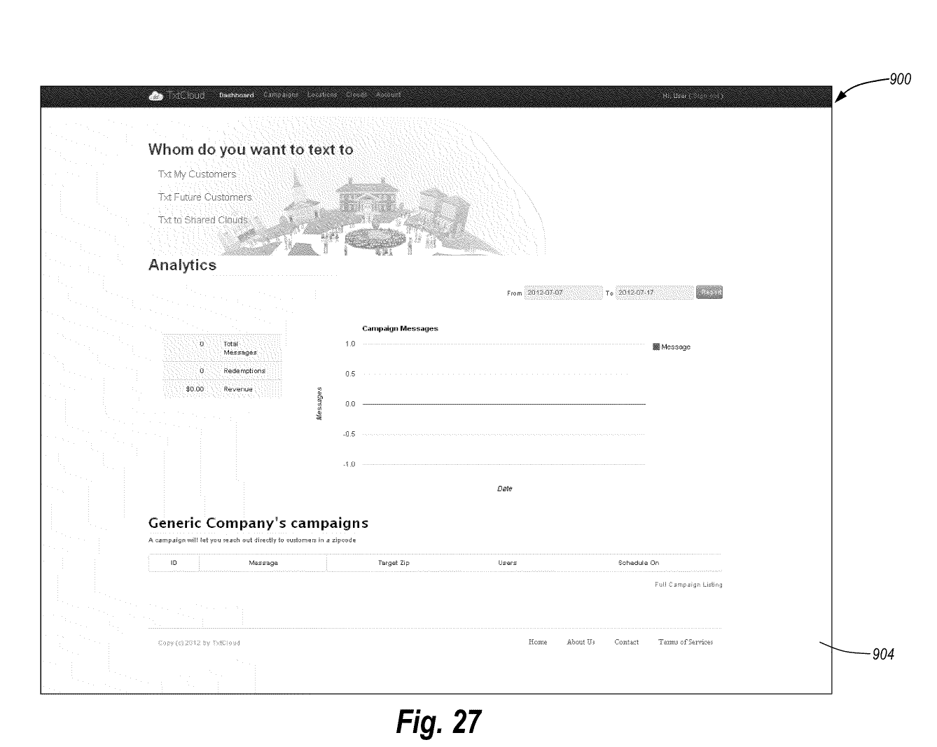

Once an account has been set-up, a user may log in and access another view. An example view 904 that may be presented after the login is shown in FIG. 27. In particular, the illustrated view 904 allows a user to select various options that include sending messages to customers, sending messages to future customers, or viewing/managing shared clouds of customers. In addition, the illustrated view 904 can allow the company to view past or saved campaigns. Such campaigns may represent different text messages that are sent out to one or more groups of customers. A history of messages may be saved, along with an option to filter campaigns and/or the number of messages sent over a period of time.

The illustrated view 904 of FIG. 27 may be considered a dashboard from which multiple options may be selected. In addition to the dashboard 904, the user may access still other views, including views related to campaigns, locations, clouds, and account information. Examples of some additional views are discussed in greater detail hereafter.

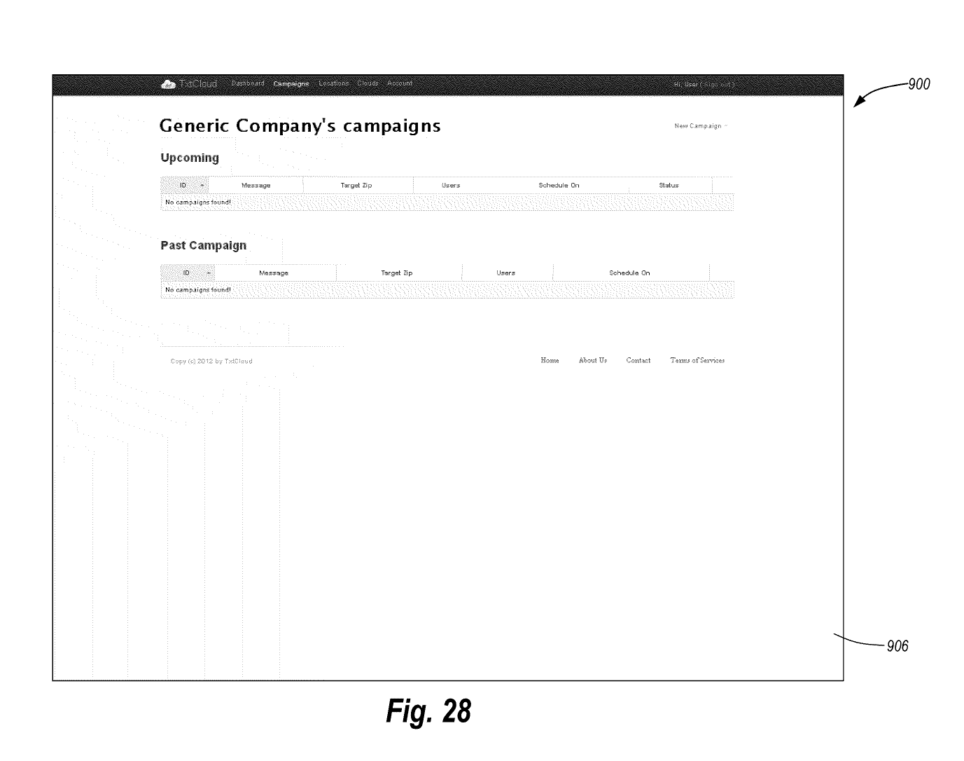

More particularly, FIG. 28 illustrates an example campaigns view 906. Such a view 906 may be used to provide information about past or future campaigns. Each campaign may correspond to a particular message sent to a particular group of people. Such campaigns are illustrated in FIG. 28 with a view 906 that includes information such as the target zip code for a campaign, a description of the users receiving the message, the scheduled time/date for the campaign, the status of the campaign (e.g., pending approval, approved, denied, etc.), an identifier associated with the campaign, or other information or some combination of the foregoing.

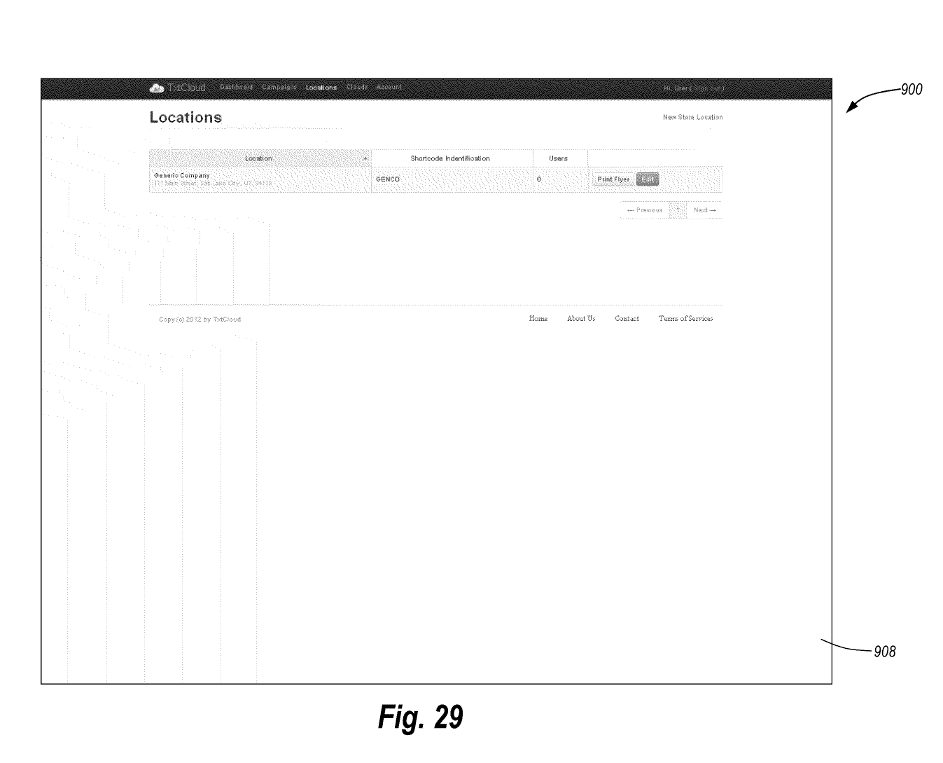

An entity using a messaging system as disclosed herein may have a single associated location, or may have multiple locations. For instance, a franchising company may have dozens or even thousands of different associated locations. FIG. 29 represents an example view 908 in which information on different locations can be provided. Information on a particular location may include the name of a location, the address, the proprietor/owner, an identifier for the location, an indication of the number or names of users associated with the location, and the like. Of course, information on a location may also be edited, or locations may be added or deleted as desired.

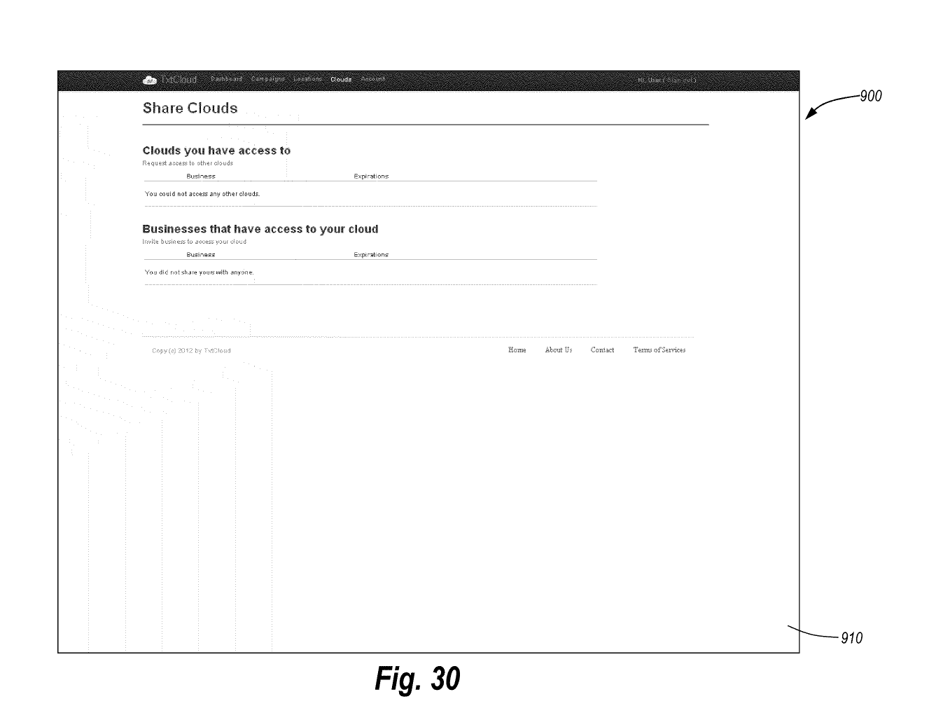

As discussed herein, users may provide others access to their customer clouds, or may be granted access to customer clouds of others. FIG. 30 illustrates an example view 910 in which such sharing of clouds may be managed. In particular, the illustrated cloud provides a section in which the user can view clouds shared with him or her by other businesses or other entities. The section may identify the sharing entity as well as a date or time at which the shared access will end. If there is no end, the date or time may be omitted (although the entity could choose to terminate sharing at any time). Similarly, the entity accessing the view 910 in FIG. 30 may also view entities with whom he or she is sharing customer clouds, manage and view expirations of the sharing, and the like.

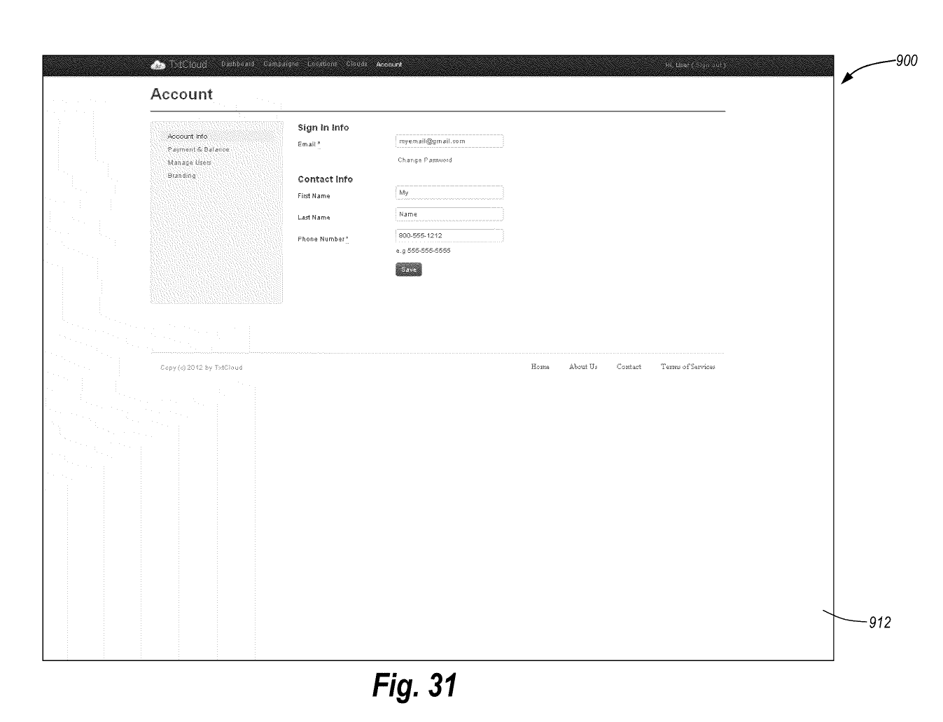

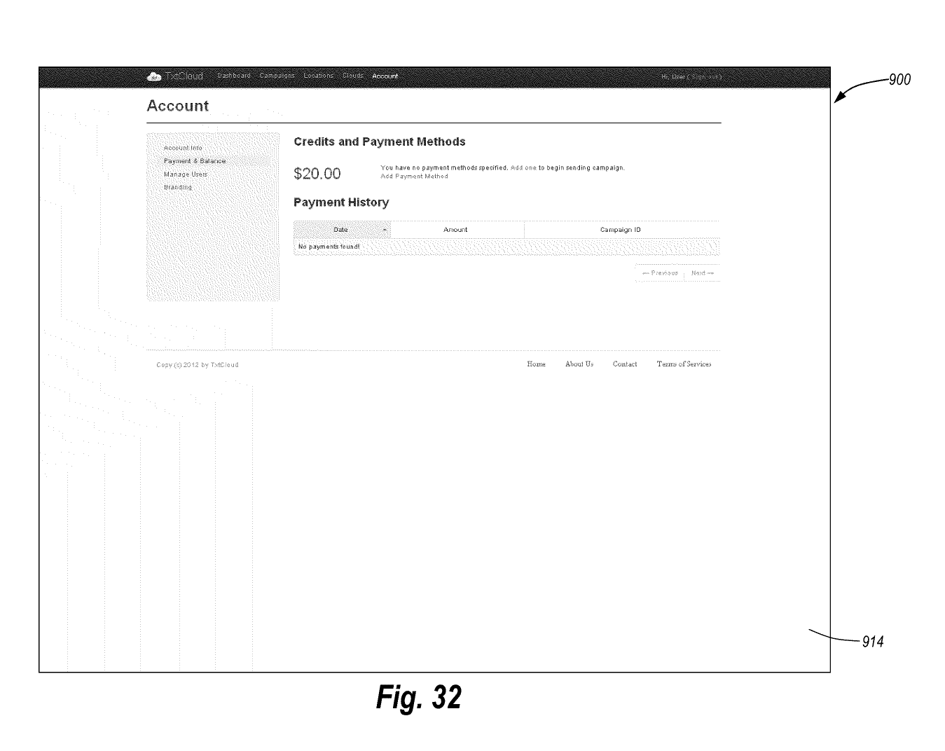

To enable a business or other entity to easily use the service provided and as discussed herein, a user may be given the ability to manage his or her account. FIGS. 31-35 illustrate example views 912-920 in which account information can be managed. FIG. 31, for instance provides a view 912 that allows a user to modify his or her contact information. FIG. 32 provides a view 914 allowing payment information to be viewed. As an example, amounts owed or provided as a credit may be provided. In addition, a history of payments and/or charges may be provided. Such payments or charges may optionally be associated with an identification of a campaign to which they correspond. Payment methods (e.g., credit card, direct withdrawal, etc.) may also be specified on the interface or linked through the view 914 of the interface 900 of FIG. 32.

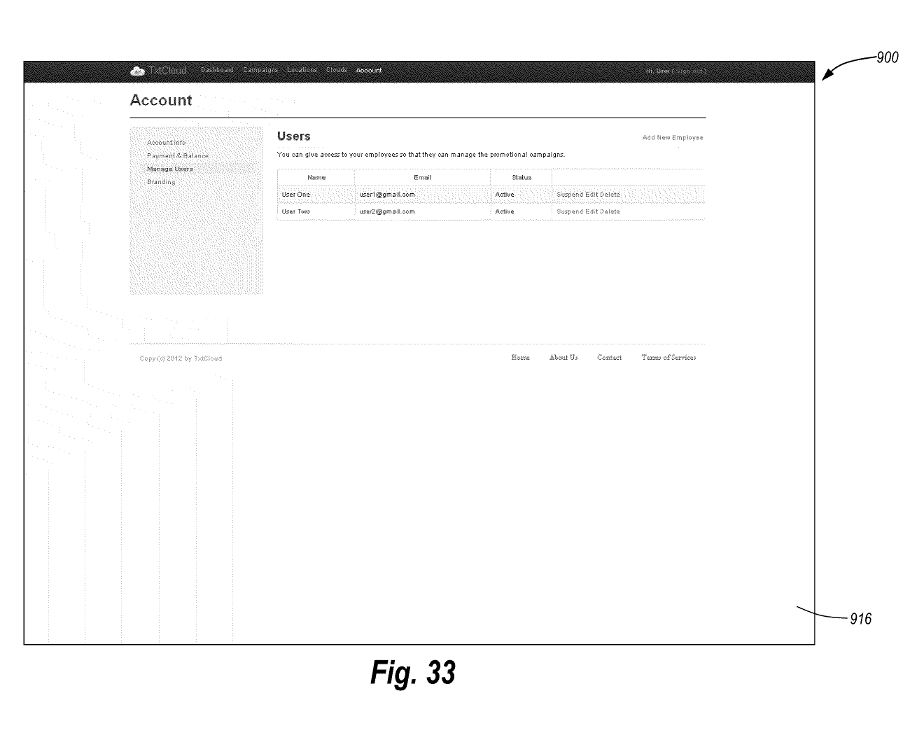

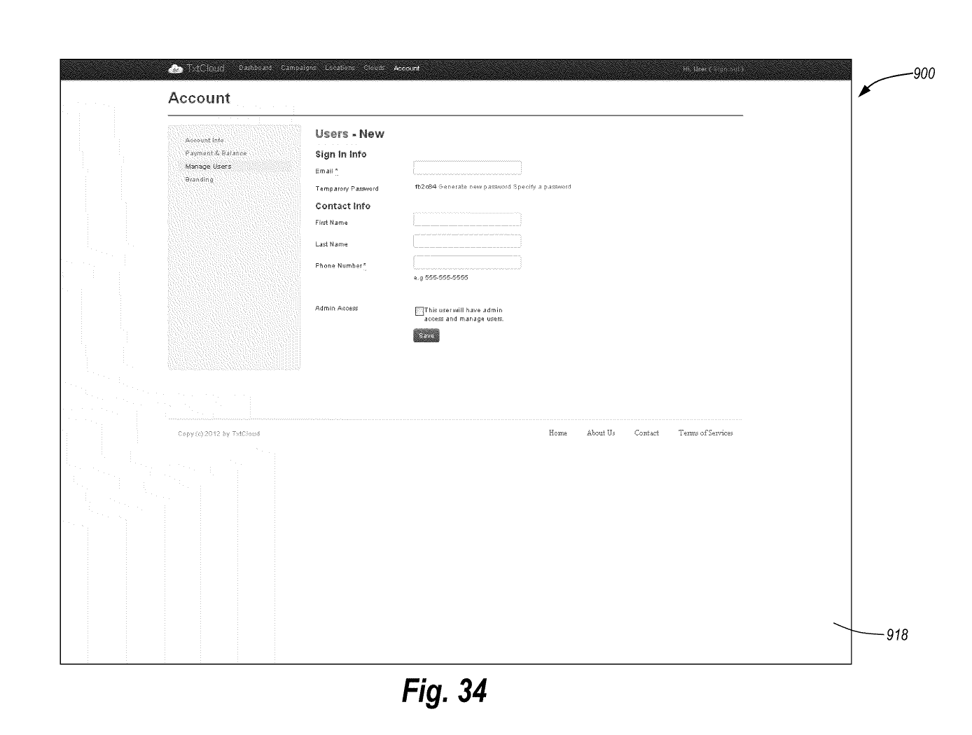

FIG. 33 illustrates the interface 900 with an additional view 916 through which an entity may manage who else may access the entity's account information. For instance, in this embodiment, two users are provided access to manage promotional campaigns or other account information. The users may be deleted at any time or may have some or all privileges suspended. Other users may also be added. For instance, in FIG. 34, a view 918 may be used to add new users. The new user can be added by specifying an email address, contact information, and the like. One or more different administrative levels may also be provided to limit the actions and abilities of the user for the account.

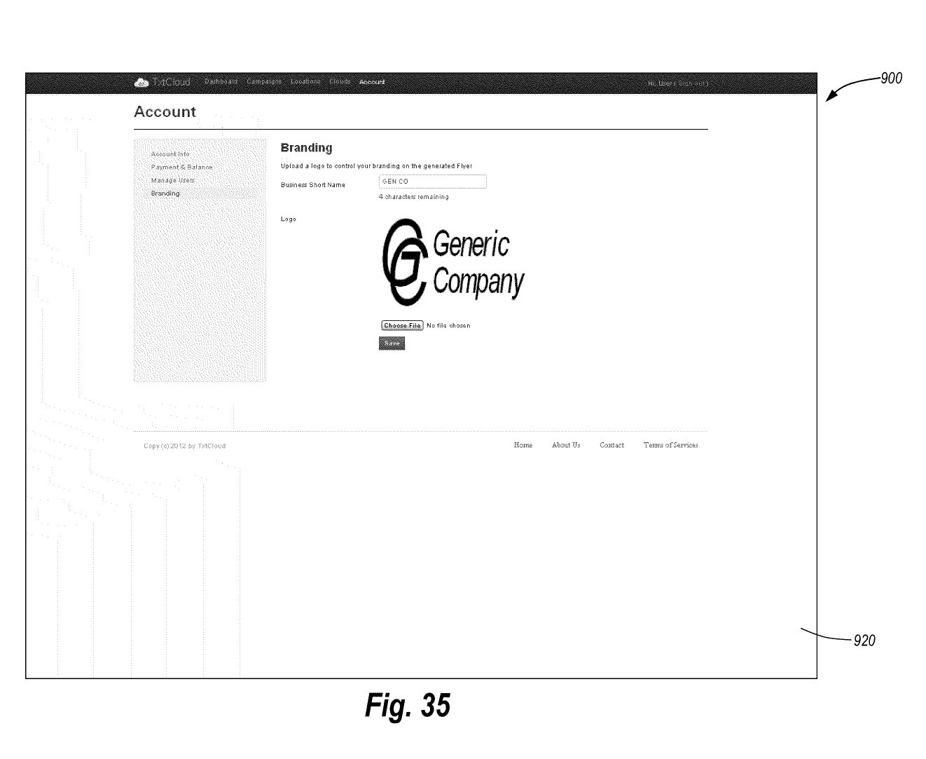

FIG. 35 illustrates still another view 920 of an interface 900 for managing an account. In this embodiment, a user can specifying its logo or other branding information. Examples of other information may include multiple logos and/or short names associated with the company.

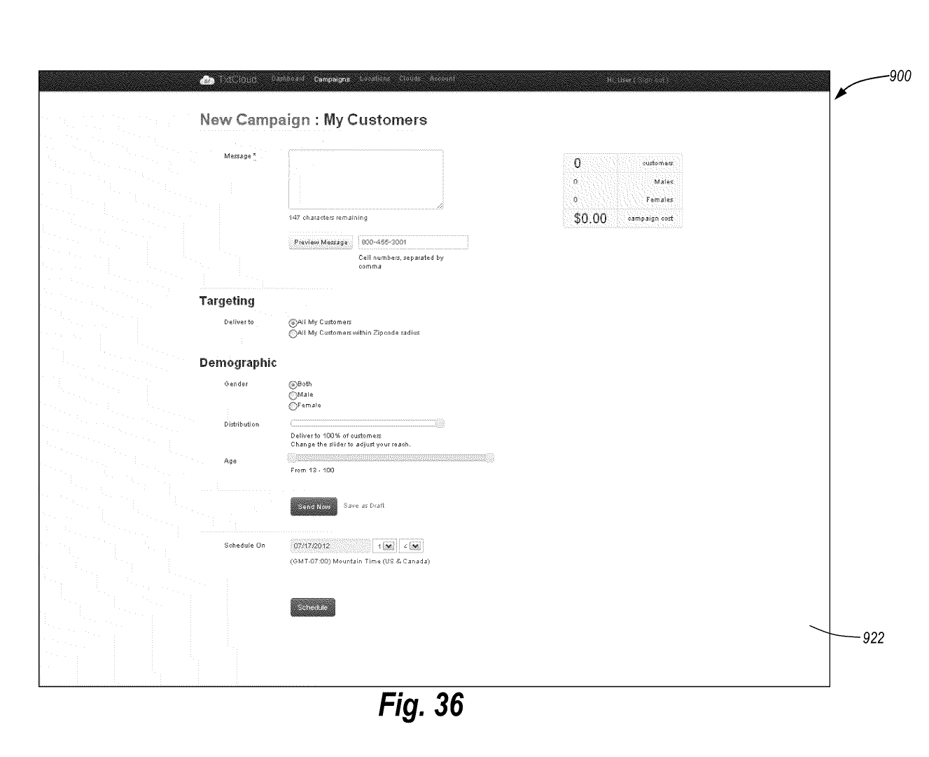

As discussed above with respect to FIG. 27, an entity having an account and using the interface 900 and/or views 902-926 of FIGS. 26-38 may use the system to send text or other types of messages to one or more other groups of consumers. FIG. 36 illustrates an example view 922 that may be presented when a user selects an option to send messages to the entity's own customers. In this view 922, the user can view or specify a message to send. Optionally, one or more numbers to which the message should be sent for a preview may also be specified.

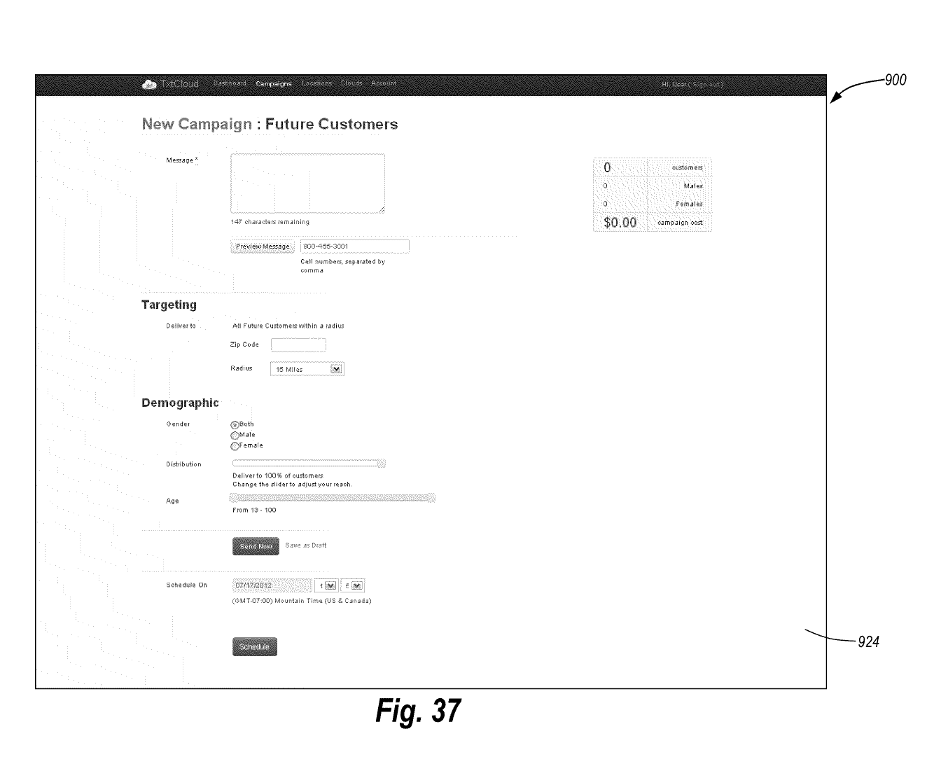

The view 922 in FIG. 36 may also be used to allow a business or entity to determine how, when and/or to whom the message is sent. For instance, the view 922 can be used to specify a target of all customers or to customers in or near a certain zip code. If, for instance, a zip code or other geographical option is provided, the user may be given an option to specify how far outside the selected zip code(s) a customer may be presently or normally located. The view 924 in FIG. 37 illustrates such an example with a radius of 15 miles, although the radius could be larger or smaller.

Other options for determining to whom the message is sent are shown, and can include a gender selection. A user may, for instance, select to send messages to both males and females, or to only one or the other as desired. An age selector may also be provided so as to allow messages to be limited to a desired age demographic (e.g., 18 to 35, 55+, etc.). In at least one embodiment, a user may limit to what percentage of the selected users the message is sent. As an example, a user may select gender, age, location, or other criteria that provides a large number of potential recipients. If the user wishes to send fewer messages (e.g., to reduce costs), the user can select a percentage of the distribution to use. Thus, a user may select to send a message to, for instance, half, of the total available users satisfying specified criteria. In some embodiments, when less than all of the available candidates receive a message, the system (e.g., a back-end server and/or database) may track who has received messages and who was not included in the particular campaign. Thereafter, if a new campaign is created at a later time, the users not previously targeted may be more likely to receive the new campaign. Thus, the same consumers may not be targeted over and over again, but there may instead be a move even distribution. In other embodiments, however, the distribution may not be even. As discussed herein, for instance, consumers who are the most likely to redeem or respond to messages may be targeted more often.

As any or all of the targeting, demographic and distribution information is specified, the number of messages to be sent can be automatically updated. As an example, the view may indicate how many customers will receive the messages, how many are male or female, and what will be the resulting cost of the messaging campaign. As also shown in FIG. 36, a user may be given the ability to save the campaign as a draft to allow it to be changed or sent later, or the user can send it immediately. Alternatively, the user may schedule a future time and/or date on which the message campaign should begin.

When the campaign is saved or sent, the campaign may optionally be routed to an administrator. The administrator may be within the company or outside of the company. For instance, an administrator within the company may be required to approve the message before it can be finally sent out in a campaign. Additionally, or alternatively, administrators of the message management system may review outgoing messages. Such review may be to ensure that offensive, abusive, or other undesired messages are not sent. Only upon their approval may the messages be transmitted to consumers.

FIG. 36 illustrates an example in which a business or other entity can send messages to consumers who have signed-up as followers of such company. As also discussed herein, however, a company may be able to send messages to followers of other companies who have opted to allow broader distribution. FIG. 37 illustrated an example view 924 in which a campaign to such potential future customers may be created. The view 924 of FIG. 37 is similar to the view 922 of FIG. 36; however, because the potential customers may not be current customers, there is no option to send a message to all customers. Instead, a user may be given some other filter (e.g., a zip code or geographical filter, etc.).

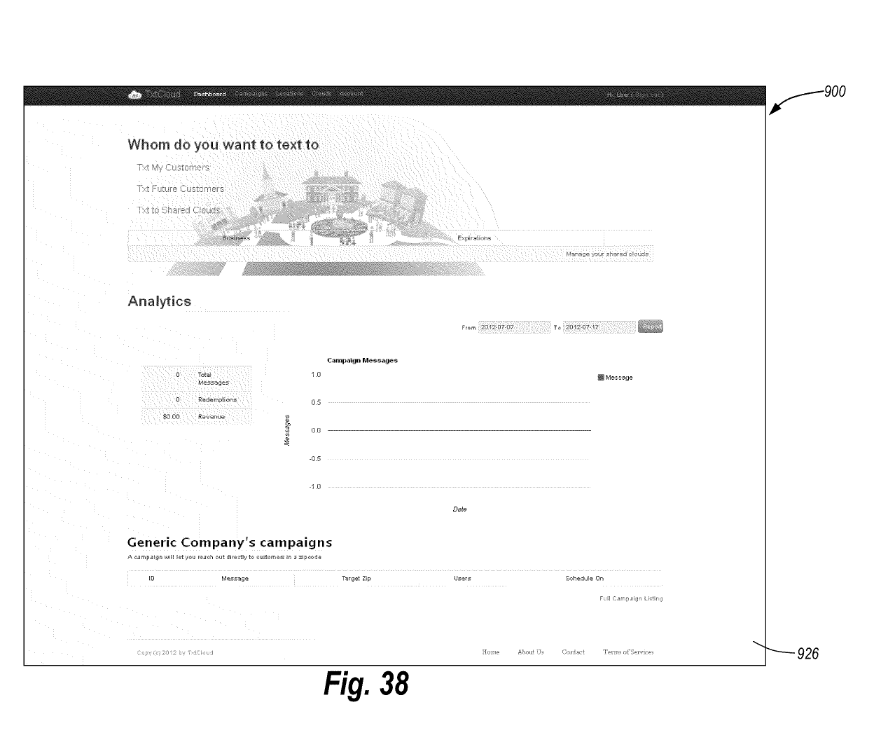

The option to send messages to shared clouds may operate in a similar manner. For instance, FIG. 38 illustrates a view 926 with an option to view shared clouds. A cloud may be selected, after which a user can be directed to a text messaging view of the interface, which view may be similar to that of FIG. 37.

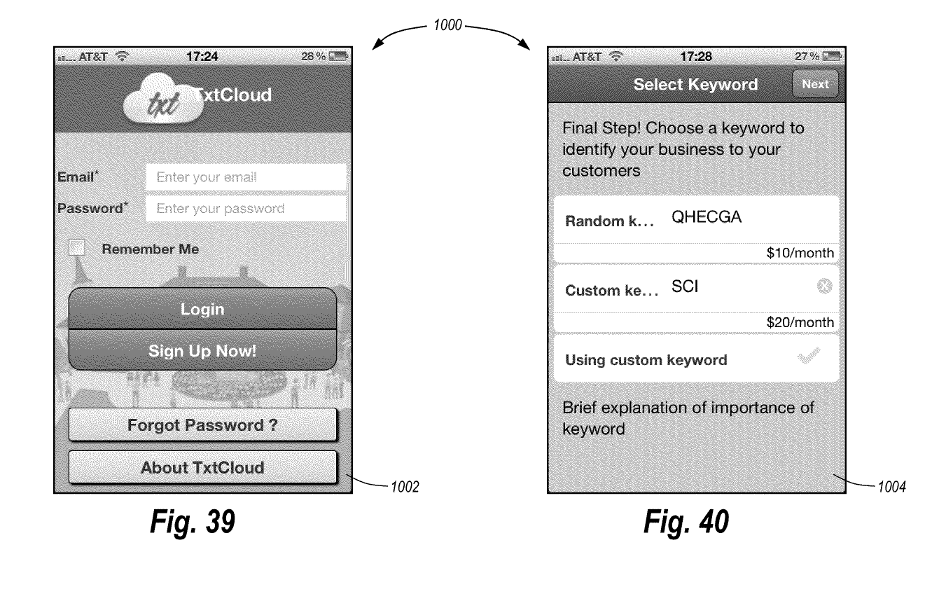

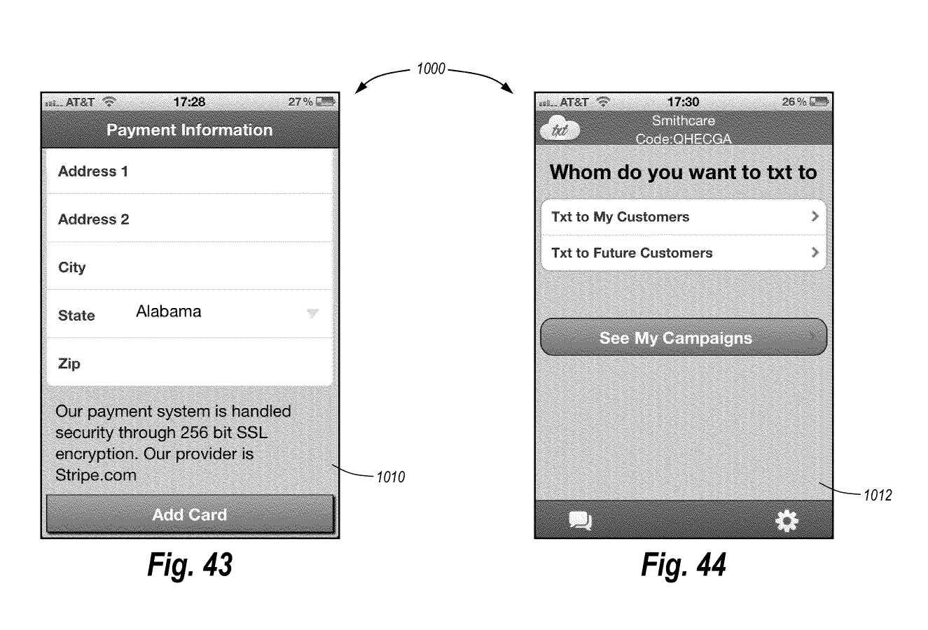

FIGS. 26-38 illustrate an example interface 900 that may be provided through a standard browser; however, the views 902-926 or other components of the interface 900 may also be part of a dedicated application that can be used on a computing device. In some embodiments, the computing device used may be a mobile device such as a tablet, smart phone, personal media player, or the like. FIGS. 39-49 illustrate example views 1002-1022 of another interface 1000 that may be dedicated for use on a mobile computing device. Such an interface 1000 may also be a general-purpose browser; however, the illustrated embodiment shows instead a dedicated application that acts as a type of special purpose browser. Information pulled into the application may be stored locally or stored remotely. In some embodiments, data or information is located in both local and remote stores. For instance, interface data may be located locally, while information about consumers, campaigns, pricing, etc. may be remote.

Many of the views 1002-1022 of the interface 1000 of FIGS. 39-49 have functionally similar to that described above with respect to FIGS. 26-39. Accordingly, the discussion of certain elements will be kept brief to avoid unnecessary redundancy.

FIG. 39 illustrates an example home page view 1002 in which a user can login to the application or interface, create an account, request information (e.g., a forgotten password, information about the service, etc.), or perform other actions. Once an account is created and the user is logged in, the user may then be directed to a view 1004 similar to that of FIG. 40. FIG. 40 illustrates an example view 1004 in which a business or other entity may create an account. As shown in FIG. 40, a user may select between different types of accounts. In this particular example, a user may select an account in which a random keyword or a custom keyword is used for the business. The keyword may correspond to the special code or word that consumers can include in a text or otherwise use to subscribe or follow a business. Based on the type of keyword chosen, different account or other charges may apply.

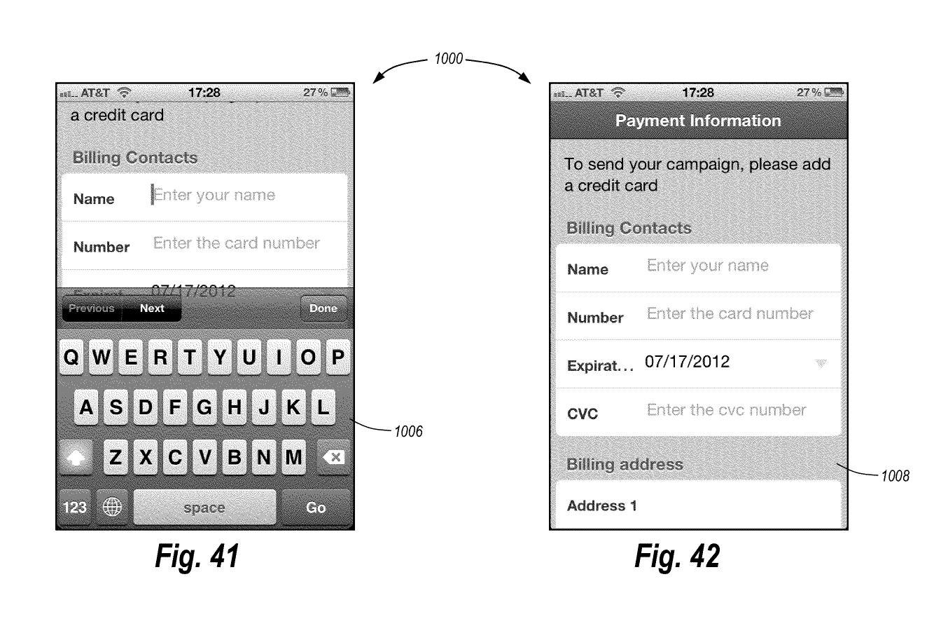

Account holders may be charged for various services, including for the account based on the type of keyword as well as for messaging campaigns. To facilitate payment of the charges, a user may set-up billing or other financial information. FIGS. 41-43, for instance, illustrate various views 1006-1010 in which a user may specify billing information (e.g., name and credit card information, a billing address, etc.). The information may be provided up-front at the time an account is created. Additionally, or alternatively, the same or different billing information may be provided on an as-needed basis, such as when message campaigns are created and text or other messages are sent out.

With an active account, an entity with an account can then proceed to send text messages to consumers. As discussed herein, recipient consumers may include those who follow or subscribe to the business, or others who may subscribe or follow similar or other nearby businesses. FIG. 44 illustrates an example view 1012 of the interface 1000 for determining which group of customers should receive a message. In particular, messages may be sent to current customers (e.g., “my customers”) or followers, or to future customers (e.g., followers of other providers). In addition, a user may view past or upcoming campaigns.

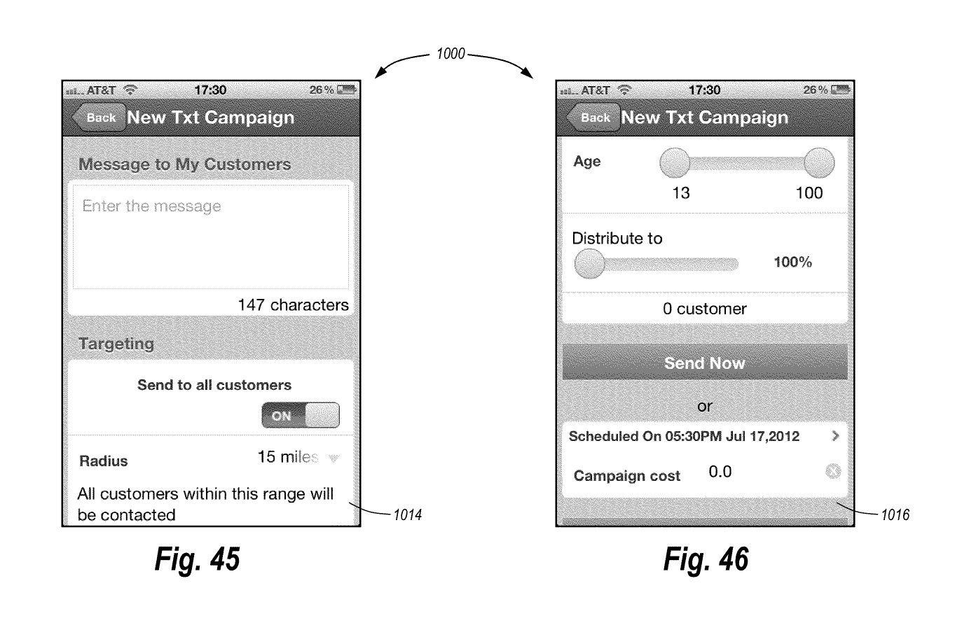

If a new text campaign is selected—whether to current or future customers—the user may be directed to an interface 1014 similar to that of FIG. 45. In this embodiment, a text message may be entered. Targeting information may also be specified. For instance, a user may request that a message be sent to all customers or customers in or near a particular geographical area (e.g., within 15 miles of a particular zip code). Determining geographical proximity may be performed by using GPS data or other data. For instance, a customer may subscribe to the service and specify one or more zip codes where they are typically located, and those zip codes may be used to determine proximity to a specified zip code.

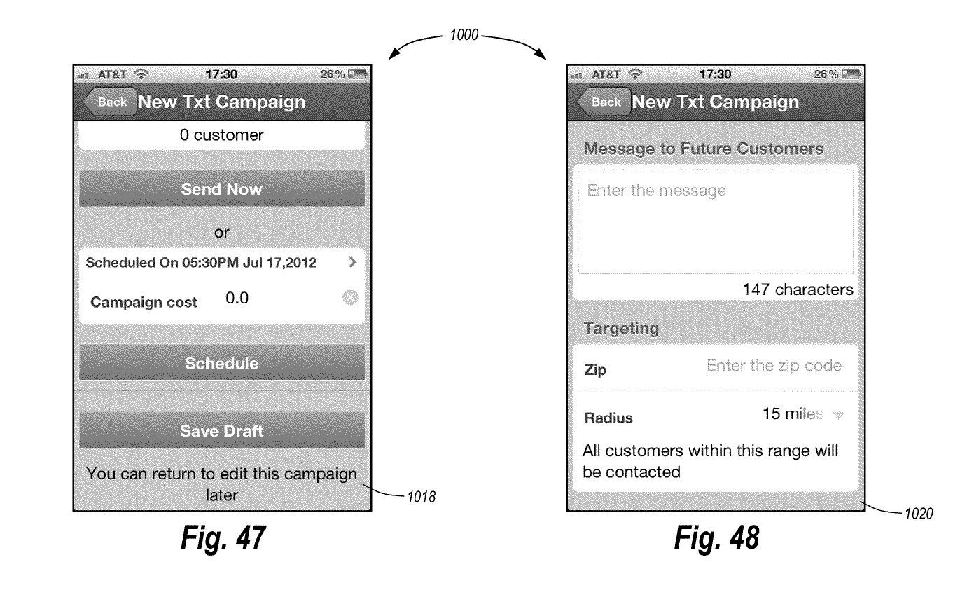

Additional filtering information may include age information as shown in the interface 1000 and view 1016 of FIG. 46. Although not shown, other filters may also be provided. Examples of filters may include filters based on gender, interests, household income, and the like. An additional filter that is shown in FIG. 46 allows an account user to select whether all or some proportion of the customers should receive the text message entered in the view 1014 of FIG. 45. Such specification may allow a user to limit costs, and the cost may also be shown in the view 1016 of FIG. 46, along with time/date information that can be set to determine when the campaign is to begin. Scheduling the messaging campaign is better understood in the context of the view 1018 in FIG. 47. In this view 1018, a service provider can choose to immediately send the messages. Alternatively, a service provider can select to schedule the campaign for a particular date/time, or simply save the campaign for later access and/or review.

Turning now to FIG. 48, another embodiment is illustrated for sending a text message to future customers. The interface view 1020 in FIG. 48 may include options generally similar to those in the views 104-1018 of FIGS. 45-47; however, the option to send to all customers in FIG. 45 is optionally removed.

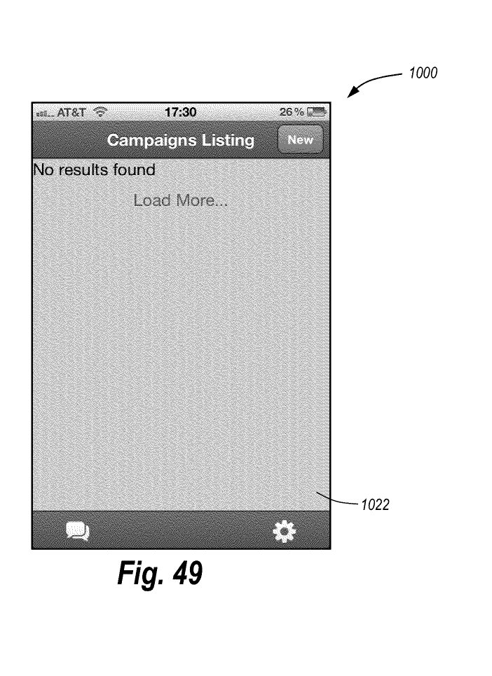

When a text message (or MMS or other message), targeting criteria, or other information is specified and saved, sent or scheduled, the collection of information may be identified as a campaign. Such information may be a campaign whether a message is ultimately distributed to a single person or a million or more people. Information on each campaign may be saved. Past, future, or current campaigns may thus be saved and viewed as desired. FIG. 49 illustrates an example view 1022 that may be used to view past, future or saved campaigns, or to create a new campaign.

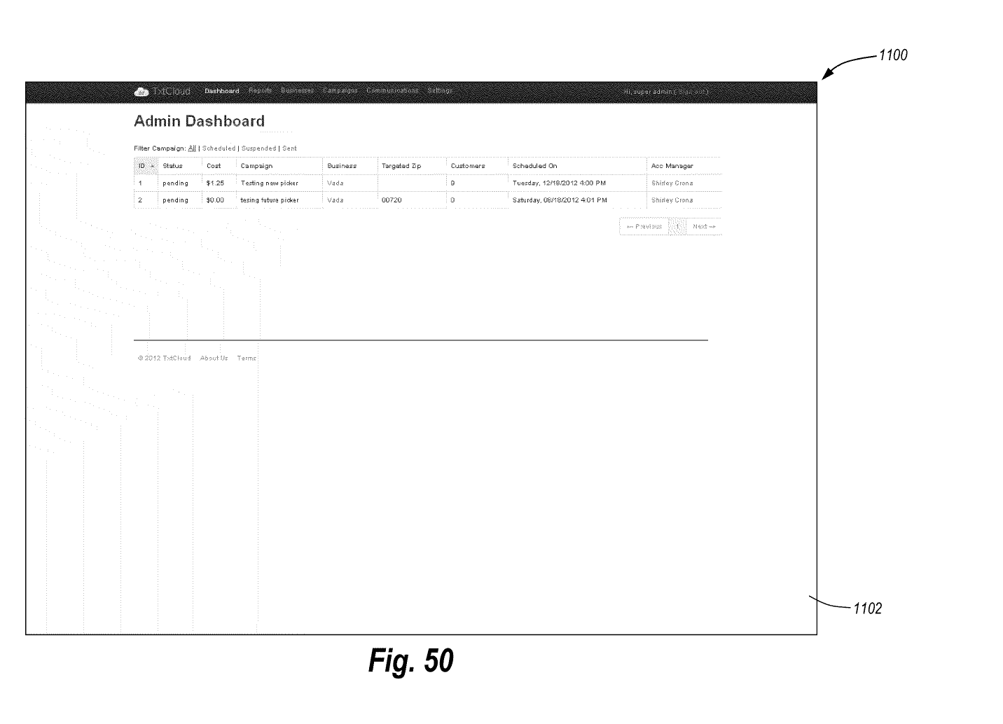

In addition to interfaces which advertisers can use to establish, use and manage accounts for sending messages, additional or other interfaces may be provided for use by consumer and/or system administrators. FIGS. 50-73 illustrate example views 1102-1148 of an example interface 1100 for administering an example system, as may be seen by one or more system administrators, account managers, or the like.

In particular, FIG. 50 illustrates an example dashboard, home page, or other view 1102 that may be used by an administrator, account manager, or other person who oversees the accounts of one or more advertisers. In the illustrated embodiment, the view 1102 may illustrate different messaging campaigns that advertisers have submitted. Example campaigns may be displayed along with information associated therewith, including information about the status (e.g., pending, completed, delayed, etc.), the name of the campaign, the advertiser (e.g., the business or non-profit) who created the campaign, the number of consumers who will receive messages in the campaign, when the messages are scheduled to be sent, and who the account manager is that is affiliated with the business. The account manager may be an employee, contractor, or other person associated with the system administrator. In other embodiments, the contact information of the user associated with the advertiser who created the campaign may instead or additionally be displayed. Other information may also be displayed, including information about targeting criteria (e.g., location, gender, age, etc.). In FIG. 50, campaigns may be viewed to show all campaigns, those that are scheduled, those that are suspended, or those that have been sent. Additional or other options, including a calendar or other filter system, may also be used to limit or restrict what campaigns are shown. Of course, a separate view may also be provided and dedicated to campaigns. As an example, an optional link for “Campaigns” is shown in the view 1102 in FIG. 50. Although not illustrated, a view resulting from selecting the “Campaigns” option may include the various campaigns of different advertisers, and such campaigns may be filtered, displayed, or viewed in a number of different ways.

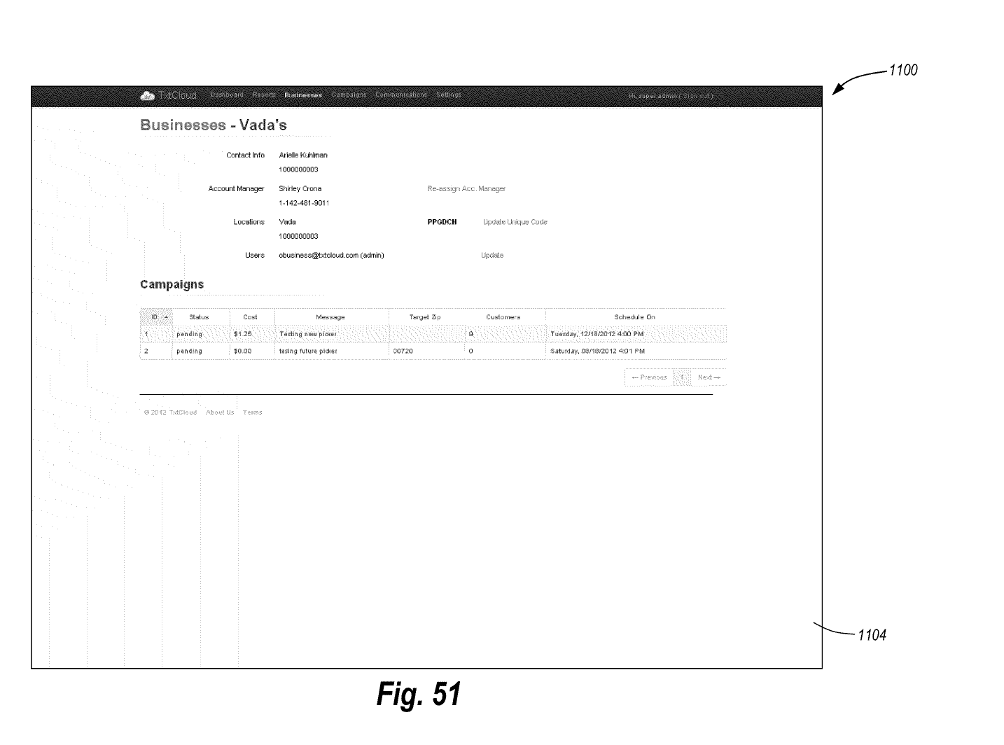

Campaigns may be shown for a single business as well. For instance, by selecting the advertiser's name identified for a campaign in the view 1102 of FIG. 50, an additional view 1104 may be displayed, as shown in FIG. 51. In this view 1104, information about a particular advertiser is presented. Such information may include contact, location and/or billing information, information about authorized users, and information on who the account manager is overseeing this advertiser. Still other information may include information on the unique keyword used by the advertiser, the account or billing tiers associated with the advertiser, and/or the past, future, or suspended campaigns of the user. Any of this information may also be edited by the administrator.

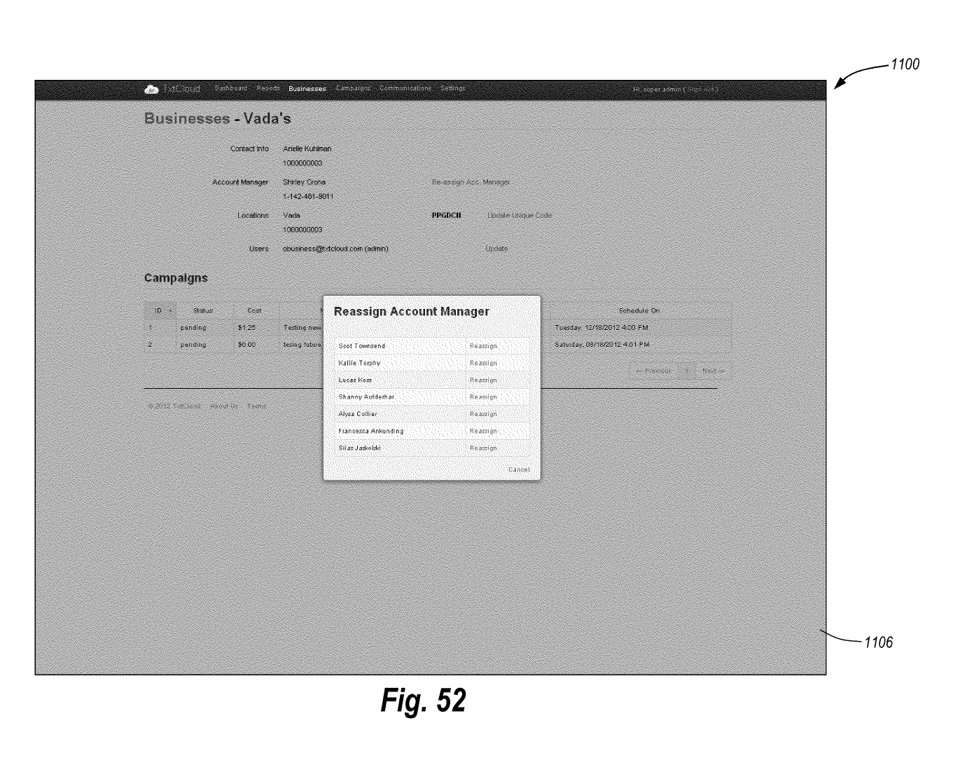

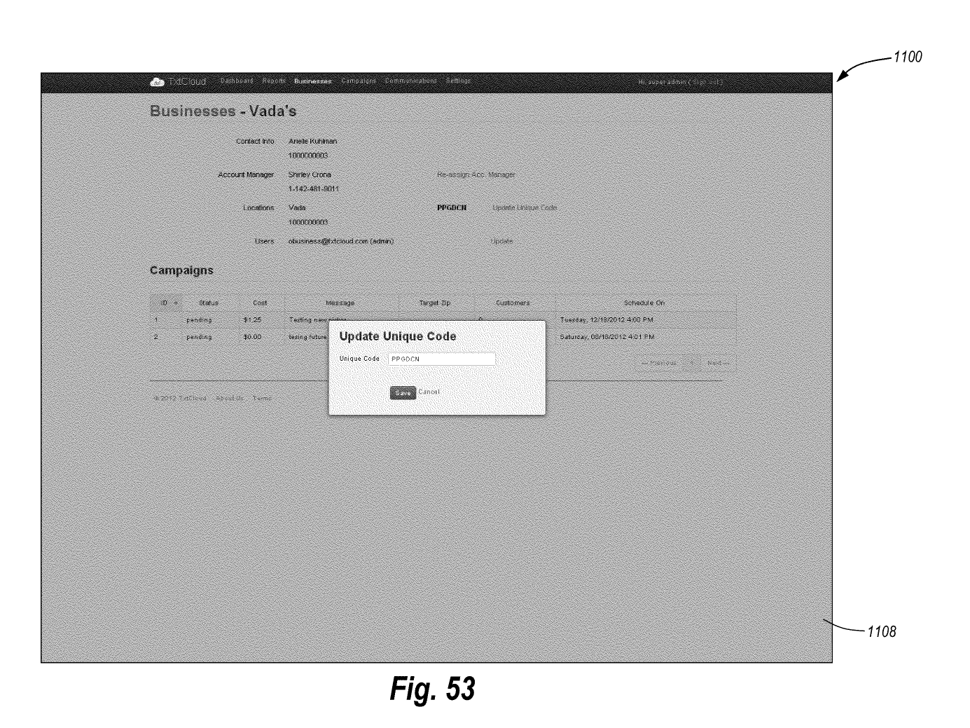

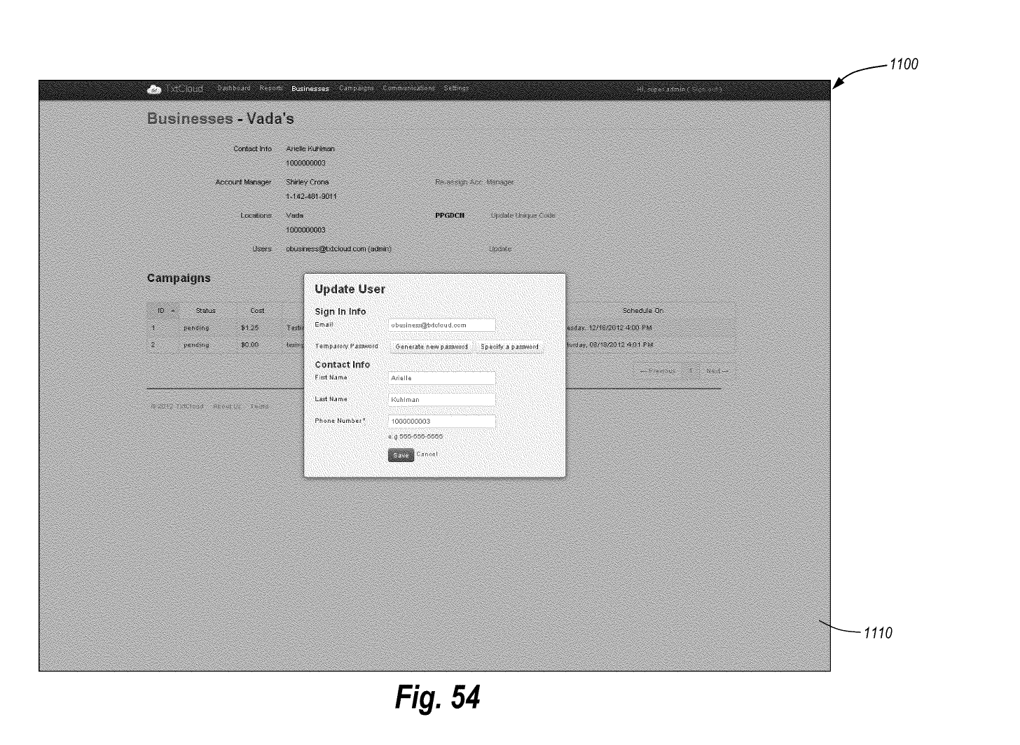

As an example, the account manager may be reassigned, and an example view 1106 is presented in FIG. 52, with this view 1106 providing an option to select a new account manager to handle the advertiser's account. Additionally, the unique keyword associated with the advertiser may also be changed, as shown in the view 1108 illustrated in FIG. 53. In still other embodiments, information about an authorized user of an advertiser may also be deleted, added or edited. FIG. 54, for instance, provides an example view 1110 in which the email, contact information and/or password of an advertiser's authorized user/administrator may be modified. In still other embodiments, a particular campaign (e.g., the message of the campaign) may be edited, or a campaign may be suspended or cancelled by the administrator.

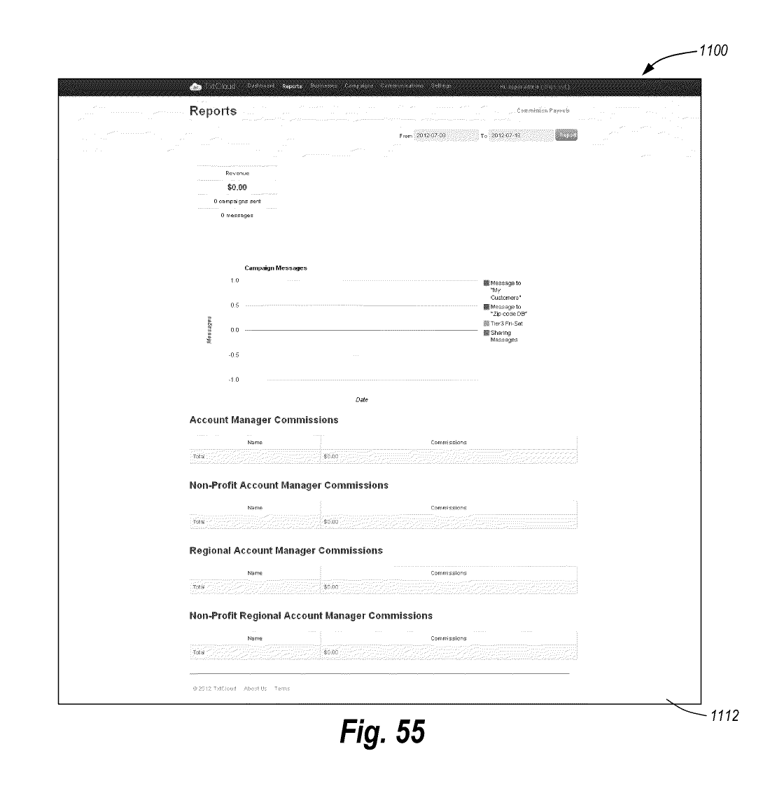

Administrators may also have the option to view reports associated with text message campaigns from one or more advertisers. FIG. 55 illustrates an example view 1112 of a reporting page. Reports may be provided for any advertiser or set of advertisers, and may span a custom or pre-defined period of time. As shown in FIG. 55, reports may include any number of different types of information. For instance, a report may show the amount of revenue resulting from campaigns, the number of campaigns completed, or the number of messages sent. Messages or campaigns may also be broken down into those that are sent by an advertiser to its current customers as compared to those sent to future customers or customers of a shared cloud. Additional filters may be applied to show messages, campaigns or income based on different billing or account pricing tiers, and the like.

Still other information shown in the reporting view 1112 of FIG. 55 may include information about account managers. As an example, account managers may receive commissions based on campaigns of the advertisers they oversee. Those commissions may be displayed and filtered based on various criteria. For instance, different managers or commissions may apply for commercial and non-profit customers, so each may be provided in reporting. Additionally, an administration system may include differing levels of managers, shown in FIG. 55 as account managers and regional managers, and each may receive some commissions based on sent messages or campaigns.

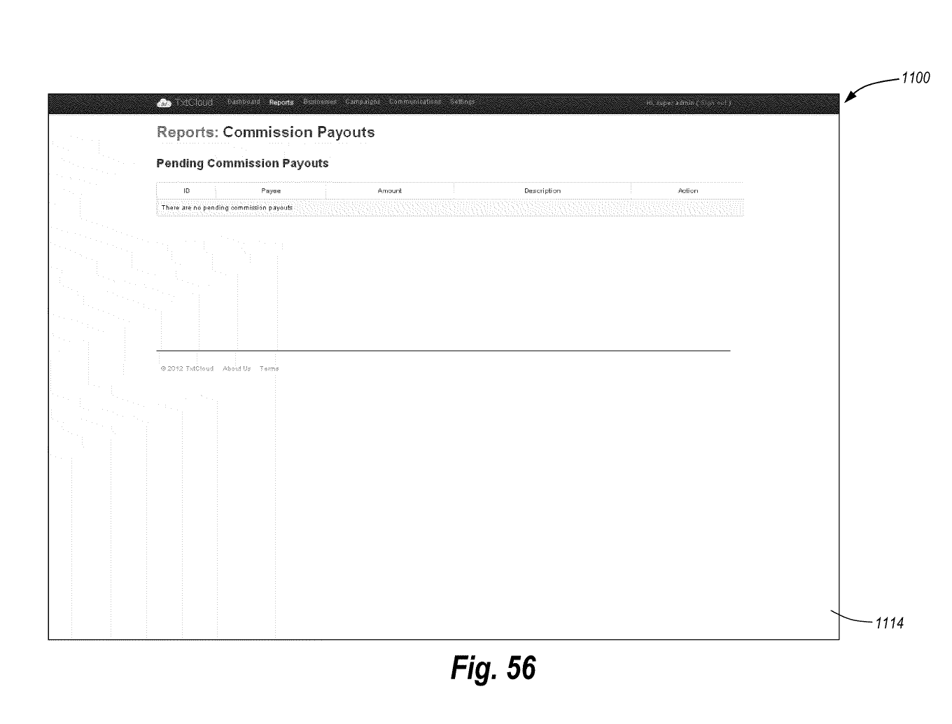

Commissions may also be approved through the administration system. For instance, by selecting a commission payouts option in the view 1112 of FIG. 55, a view 1114 such as that in FIG. 56 may be provided. This view 1114 may be used to list who is owed a commission, and other information about the commission. Example information may include the amount and a description of why the commission is owed. An action related to the commission (e.g., approve, pending approval, denied, etc.) may also be displayed. In addition to commissions, similar interfaces may also be provided to view amounts distributed to non-profits in certain systems and methods disclosed herein.

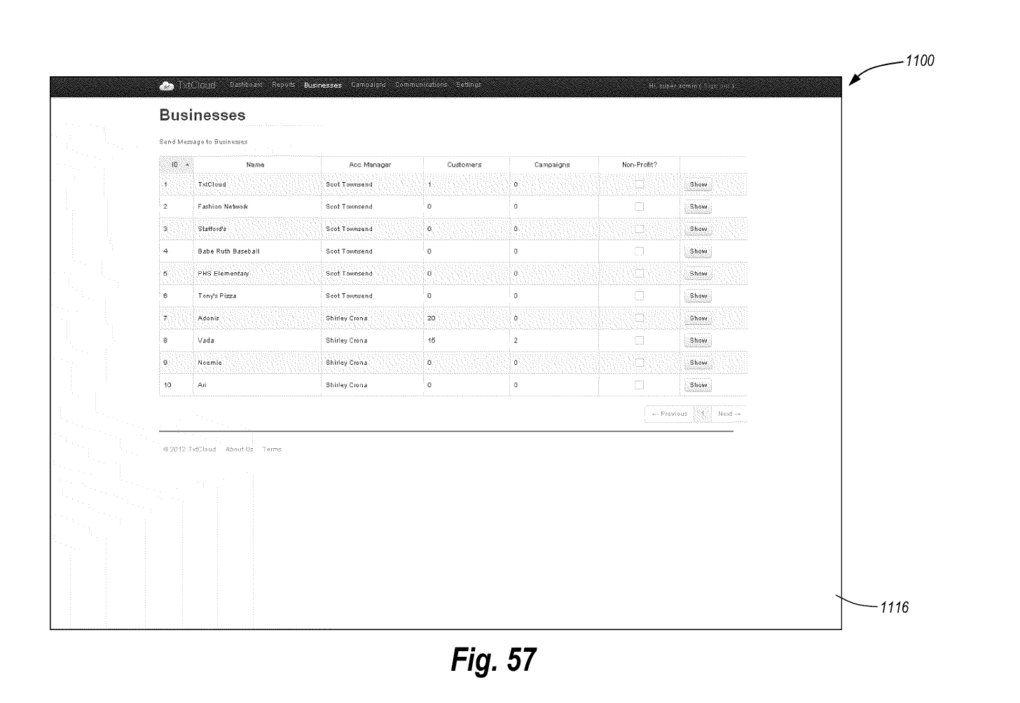

Another example view 1116 of an administrator interface is shown in FIG. 57. In this particular embodiment, an administrator, account manager, regional manager, or other authorized user may view the businesses, non-profits or other organizations that use the messaging system provided. Various entities may be displayed along with information related thereto. Such information may include information about the advertiser (e.g., name, contact information, primary contact, etc.), the account manager for the advertiser, the number of customers who are currently signed-up or following the advertiser, the number of campaigns created, and the like. Optionally, information may be provided to describe the nature of the advertiser, including whether the advertiser is a non-profit.

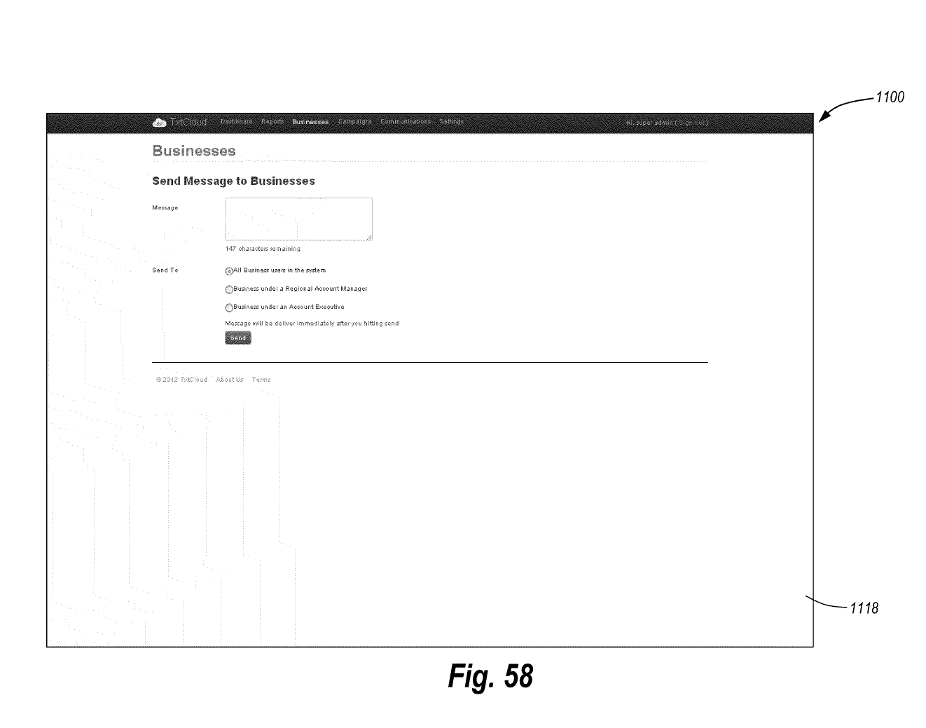

At times, it may be beneficial to communicate with these advertisers. One optional aspect of the system may include a messaging system for communicating with related companies or users, rather than with subscribers/customers or potential customers. For instance, by selecting the company name, or a link to send messages, a messaging view 1118 such as that in FIG. 58 may be provided. If a general messaging option is selected, additional filters may be provided to limit the businesses who receive the message (e.g., those of a particular regional or account manager, those of a particular location, etc.).

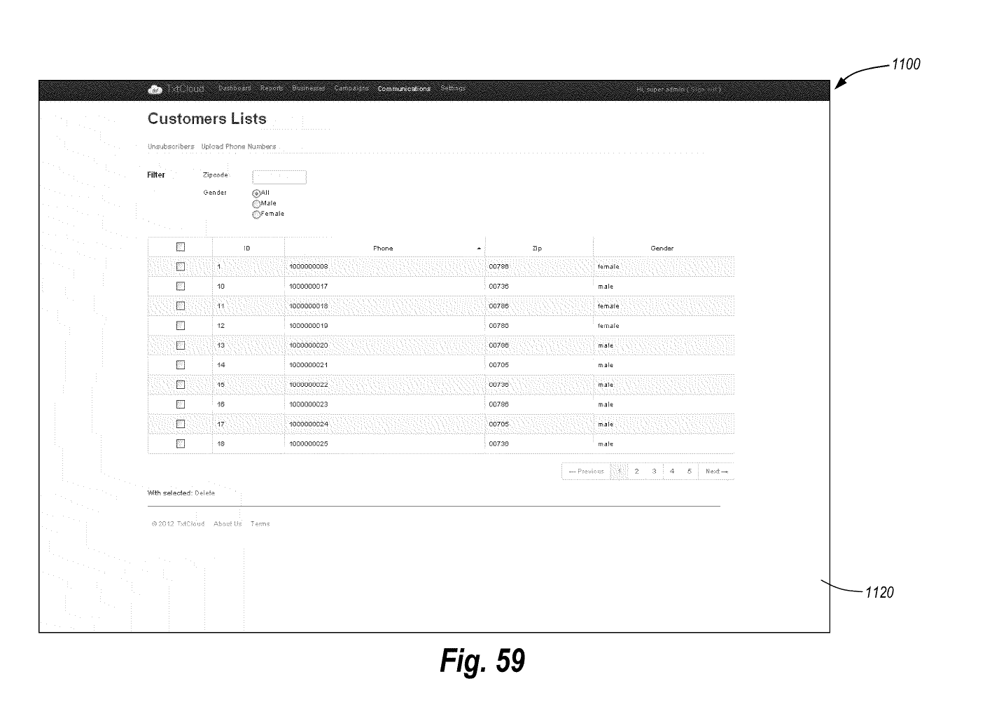

Inasmuch as consumers may opt-in or otherwise choose to receive messages, information about the different consumers may also be stored and optionally viewed. In FIG. 59, an interface view 1120 provides a list of different consumers, along with some information about them. Such information may include the consumer's phone number or other information for receipt of a message, one or more associated zip codes, and their gender. A unique ID may also be associated with each consumer. Consumers may then be filtered based on various criteria, including the consumer's gender and location. Other filters such as who the consumers follow or subscribe to may also be provided; however, in some embodiments the information on the consumers is restricted to administrative-level users and not made available to advertisers themselves.

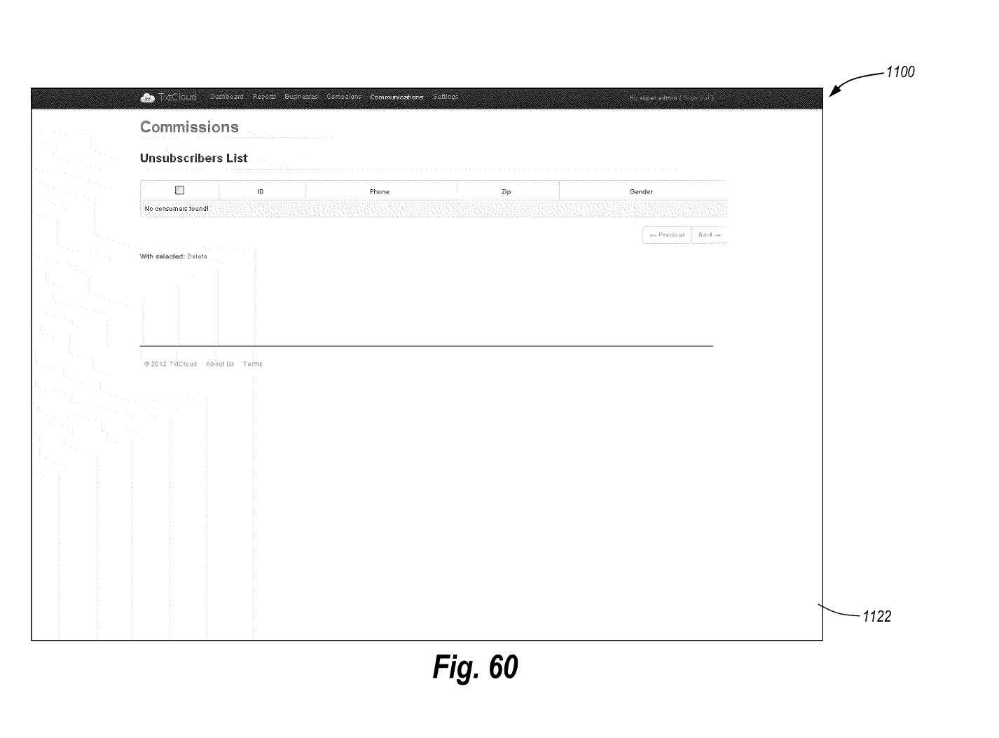

As the system is used, some consumers may choose to no longer be associated with a particular advertiser, or opt-out of the system entirely. FIG. 60 illustrates an example view 1122 that may be used to list unsubscribed users. Information in the list may include the same or different information as compared to the list in the list of all consumers, an example of which is in FIG. 59 as discussed above.

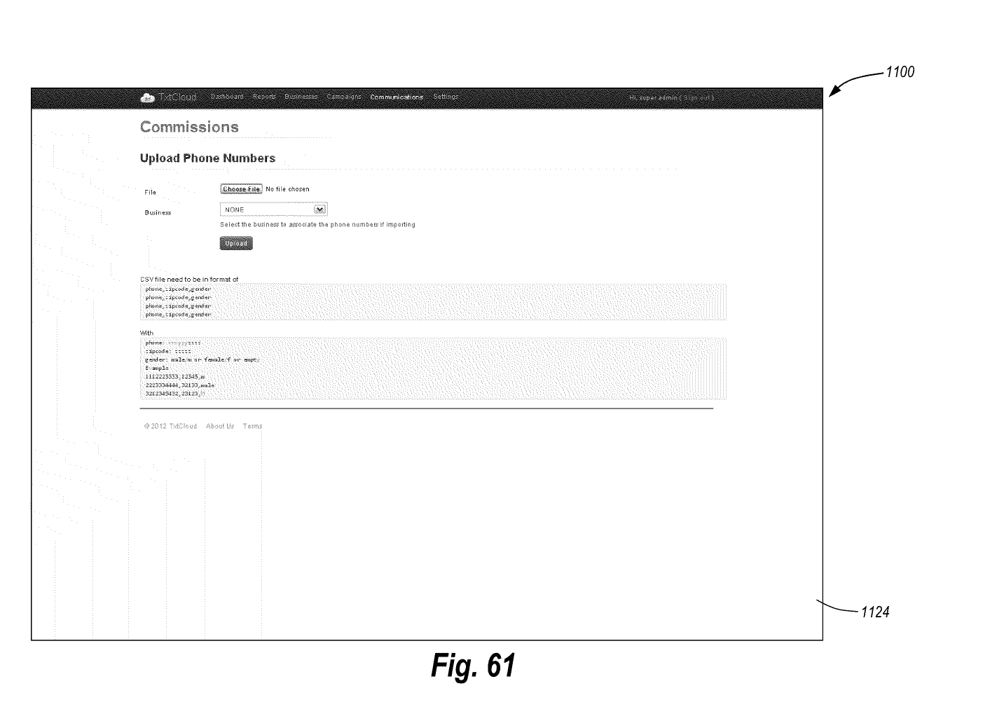

As discussed herein, consumers may sign-up for the service or follow different advertisers by opting-in using a text messaging, email or other system. In other embodiments, a consumer may opt-in in other ways. For instance, a user may fill out a survey in a store and ask to be notified of advertisements and deals in the area. In such a case, information may be provided manually to the system. FIG. 61 illustrates an example view 1124 in which a file may store information on consumers and be uploaded to add the customers to the database. The customers may be added and associated with a particular business. If a customer is already stored in the database, the information may not be added, or the business may be added as one followed by the customer in case the customer is not already following such business.

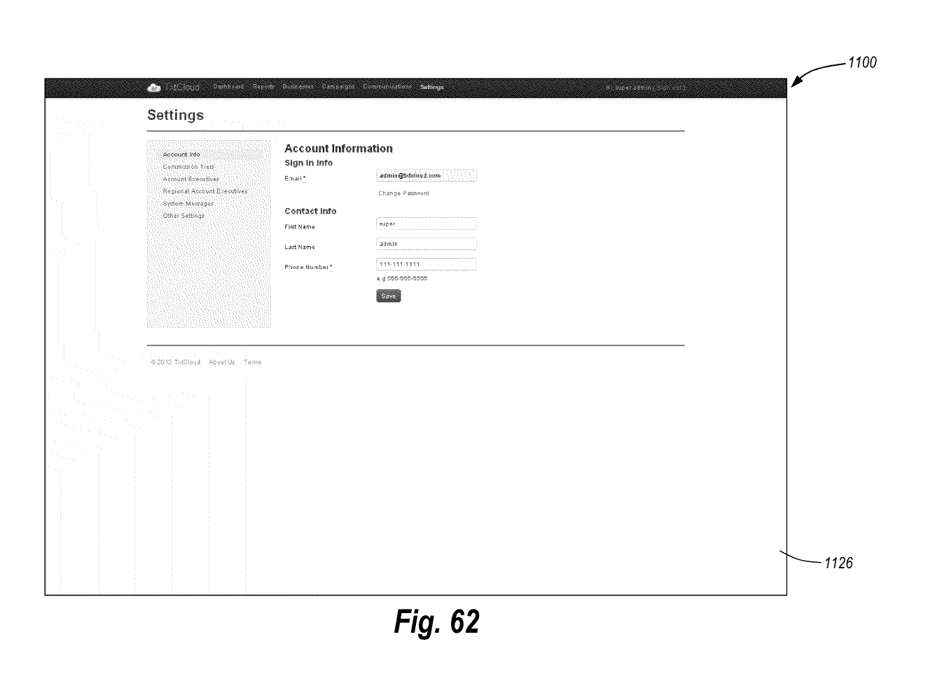

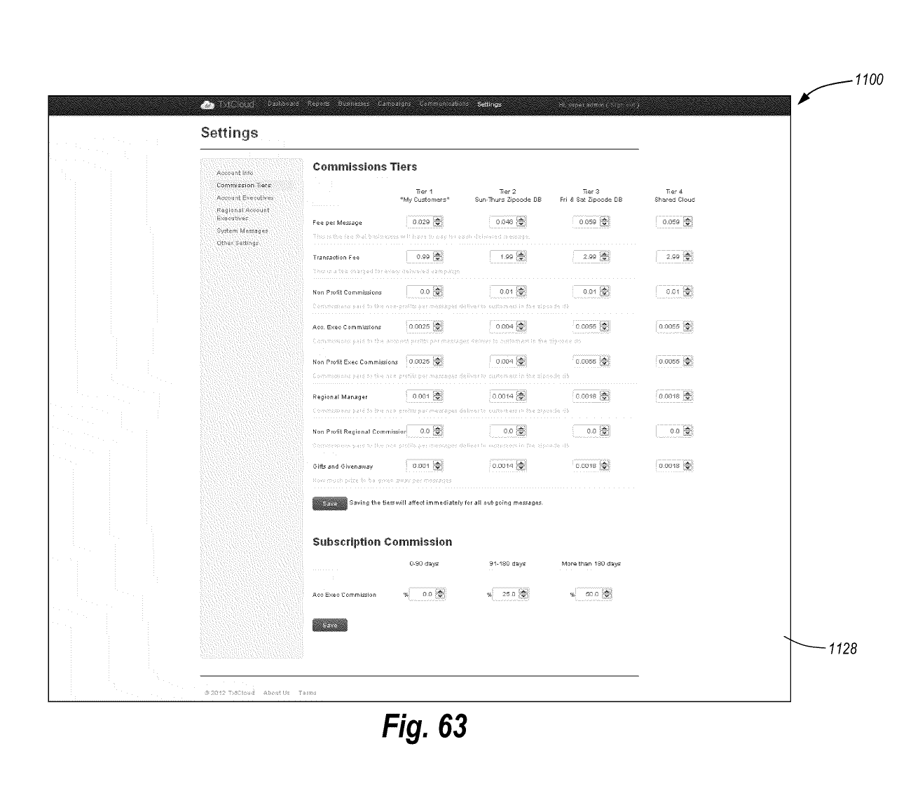

The administrator may also adjust various settings within the system. FIG. 62 illustrates an example view 1126 of a settings interface in which information of the administrator-level user may be changed or viewed. In FIG. 63, the administrator may view and change different pricing and commission information using a view 1128. For instance, in this embodiment, different pricing tiers are provided. One tier, for instance, may be for sending messages to an advertiser's own customers. Another may be provided for sending messages to customers based on a zip code or other filter. In this particular embodiment, two tiers are provided for zip code, with one tier being associated with messages at certain times (e.g., Sunday-Thursday), while another, higher priced tier is associated with other times (Friday, Saturday). Such tiers may reflect that higher costs are associated with times when demand is higher and/or when consumers are more likely to be available to promptly act on a received advertisement. Still another tier is shown for messages sent using a cloud shared by another entity.

In addition to tiers for fees for sending of messages, additional fees may be specified. For instance, a per-transaction fee may be specified (e.g., fee for a campaign, regardless of the number of messages sent). Additional fees entered or visible on the view in FIG. 63 may include commissions payable to account executives or managers, regional managers, and the like. Still other fees may be those to be paid to non-profit or other similar organizations. For instance, as discussed herein, a customer may specify a particular non-profit, and for each message that customer receives an amount may be provided to the specified non-profit (e.g., the “Gifts and Givenaway” category. In other embodiments, if a non-profit signs up a customer and that customer receives messages as a result of their location or being part of a shared cloud, the non-profit may receive a commission. Account executives or others that receive commissions may also receive commissions in other ways. As shown in FIG. 63, for instance, commissions may be based on subscriptions where the account remains with the service provider for different durations of time. Commissions may also be different for businesses and non-profits, and can even be calculated differently. As an example, an account executive for a business may receive a commission based on every text message a business sends. In contrast, an account executive for a non-profit may receive a commission for each text message received by a follower of the non-profit.

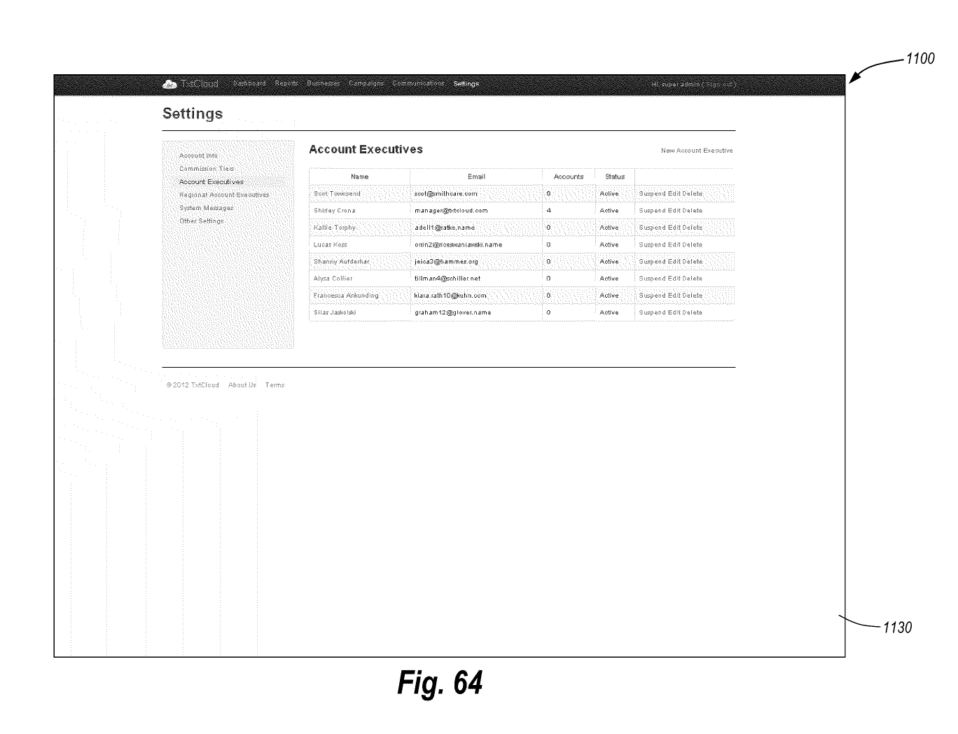

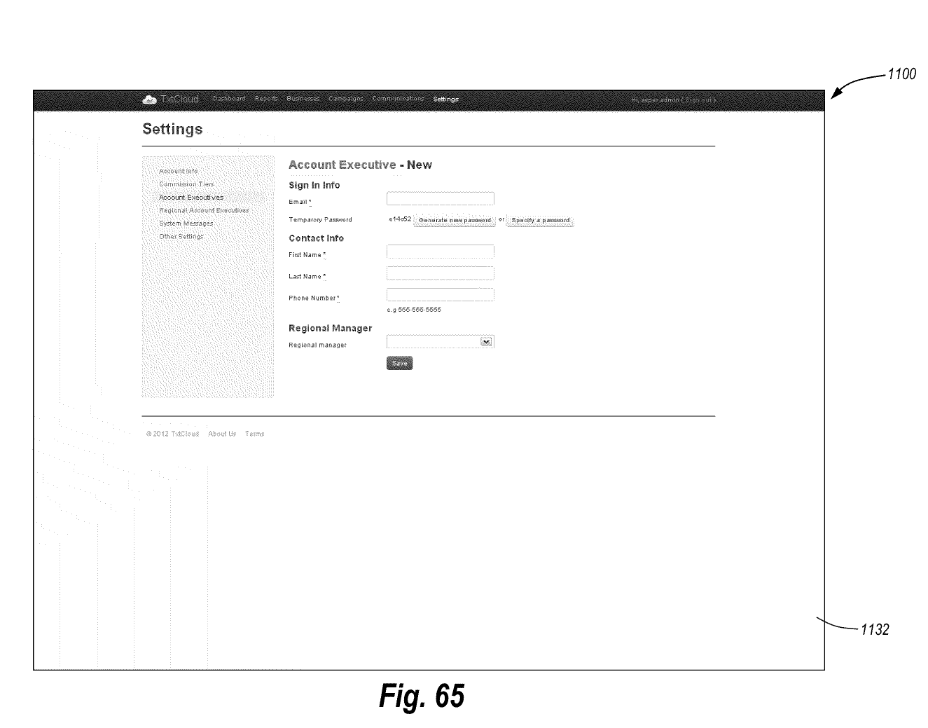

A further example of a settings view is shown in FIG. 64 which illustrates a view 1130 including a list of account executives. Each account executive may be listed along with information such as contact information (e.g., email or phone number), the number of advertiser accounts they manage, whether they are currently active or not, or the like. Additionally, an administrator may suspend, edit or delete information corresponding to the account executives or managers. New account executives may also be added, as shown in the view 1132 of FIG. 65. In this embodiment, a password can be created for the new account executive and the account executive can be assigned a particular regional manager.

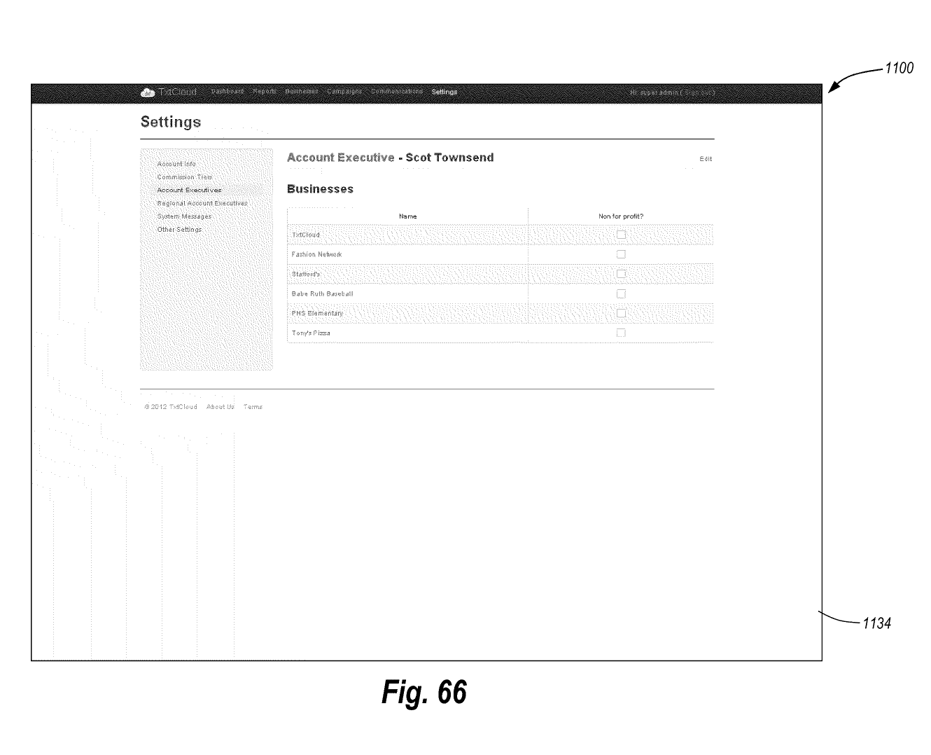

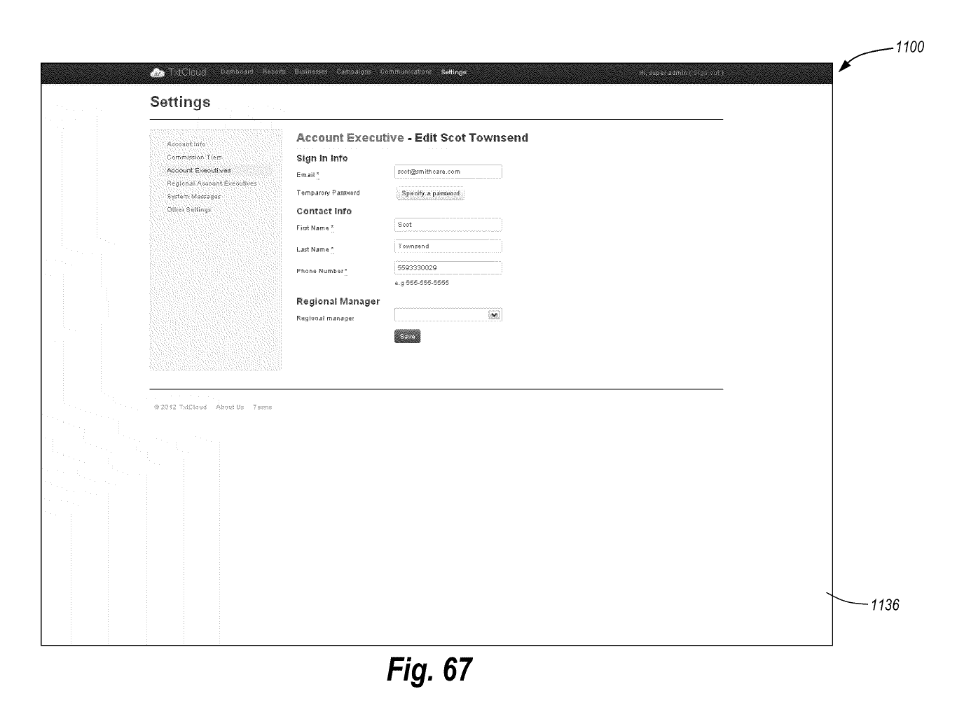

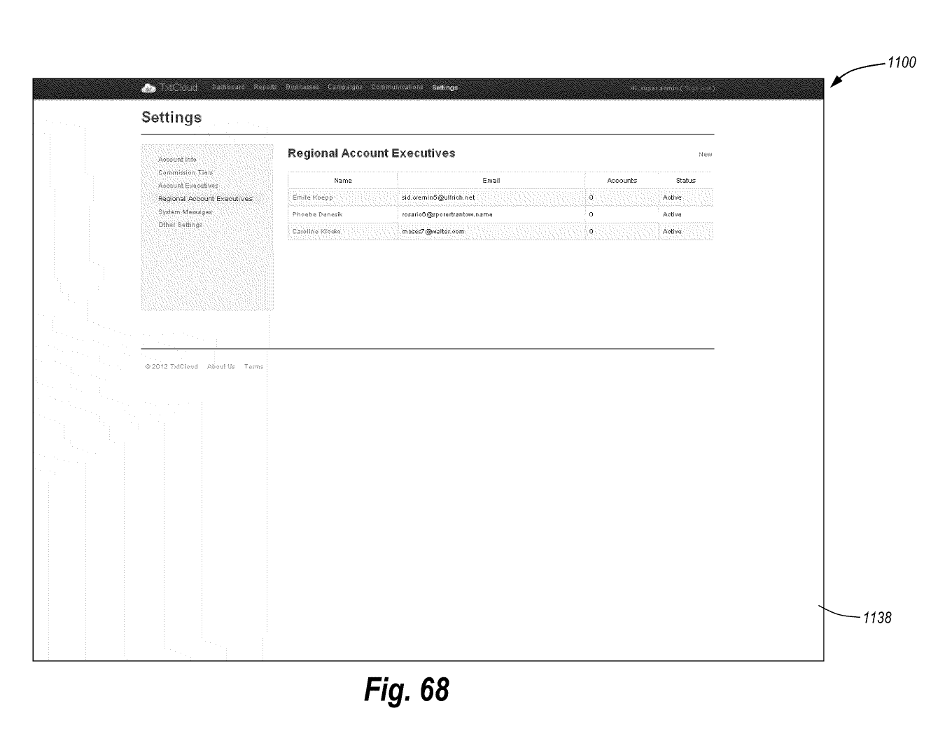

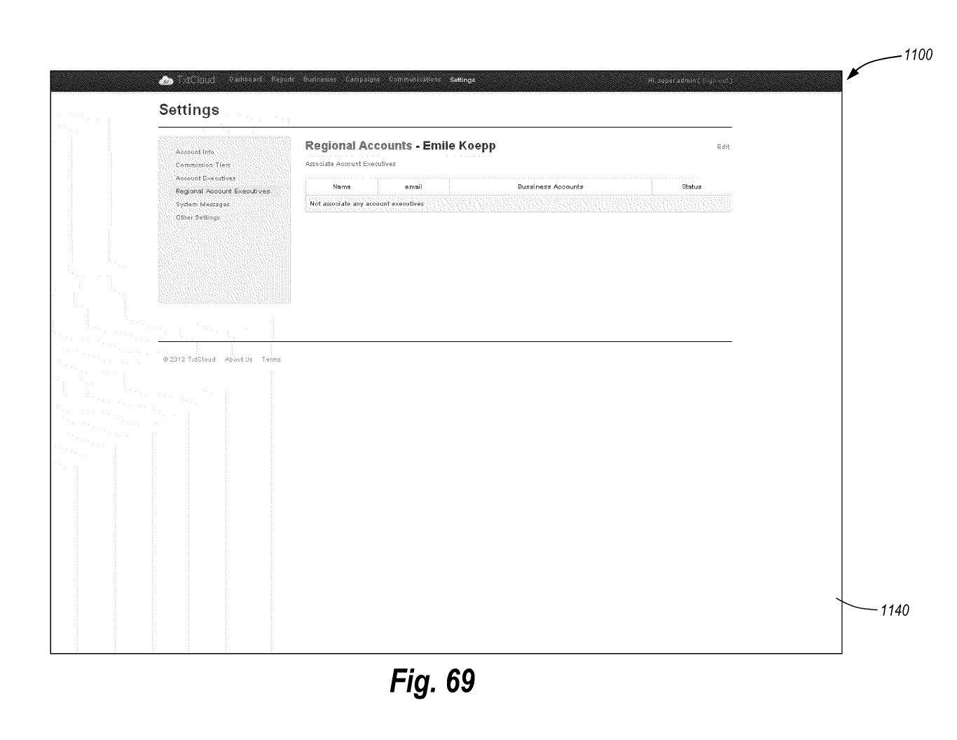

In some embodiments, the account executive listed in the view 1130 of FIG. 64 may also be selected. A view 1134 such as that in FIG. 66 then shows information about the executive, including what advertisers the account executive manages. Contact information, and other information could also be displayed as it relates to the particular account executive. The view 1136 in FIG. 67, for instance allows an administrator to view or edit the account executive's information. Similar functionality may be provided for regional account executives or managers as shown in the view 1138 of FIG. 68 and the view 1140 of FIG. 69.

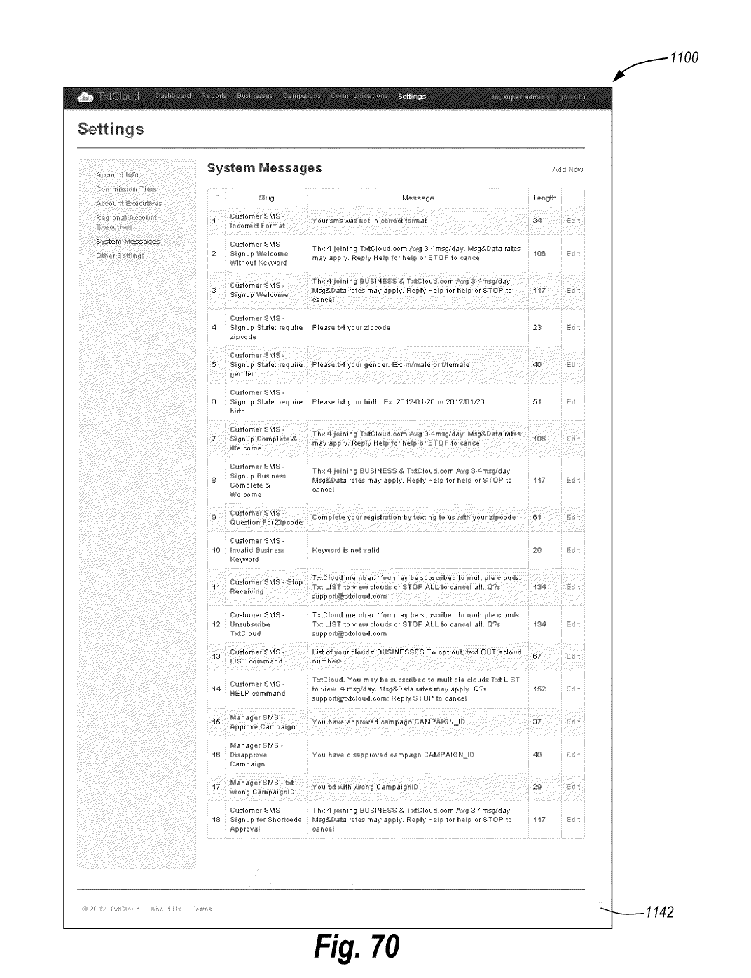

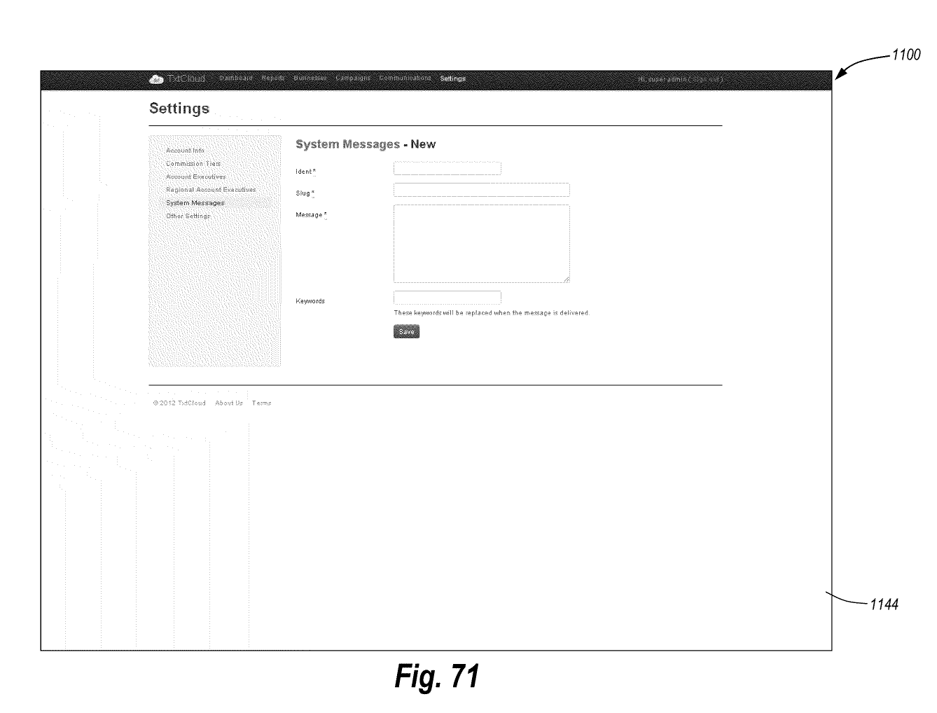

An aspect of some embodiments of the present disclosure is that a user can opt-in for a service and then information is provided to the user. FIG. 70 illustrates some example system messages that may be provided to a user to provide such information. As an example, the illustrated messages may be provided for a text or MMS messaging system, but the same or other messages may be specified for other text email, MMS, or other messaging systems. For simplicity, the illustrated eighteen messages in the view 1142 may have the following purposes, although messages of other types may of course be included:
1. To indicate that a received message was not understood as the format was incorrect.
2, 7. To indicate that the opt-in message was received and notify the consumer of the number of messages that may be recited per day (or week), that messaging rates may apply, etc. May also provide information to indicate response messages the consumer can send to stop the service or to get help or additional information.
3, 8, 18. May have the same purpose as messages 2 and 7, but can also indicate what advertiser the customer is following.
4. To request that subscribed customers provide their zip codes.
5. To request that subscribed customers provide their genders.
6. To request that subscribed customers provide their ages or birthdates.
9. To request that subscribed customers complete registration by providing their zip codes.
10. To indicate that a keyword received is not recognized as corresponding to an advertiser.
11, 12, 14. To indicate that a subscribed customer is associated with multiple advertisers and provide information on stopping messages or unsubscribing from all clouds, how to list the different clouds, or who to contact for help.
13. Provide a list of clouds/advertisers to which the customer is subscribed (e.g., in response to a particular message sent by the consumer).
15. To indicate to an account manager that he or she approved a campaign.
16. To indicate to an account manager that he or she denied approval of a campaign.
17. To indicate to an account manager that a campaign ID is incorrect.

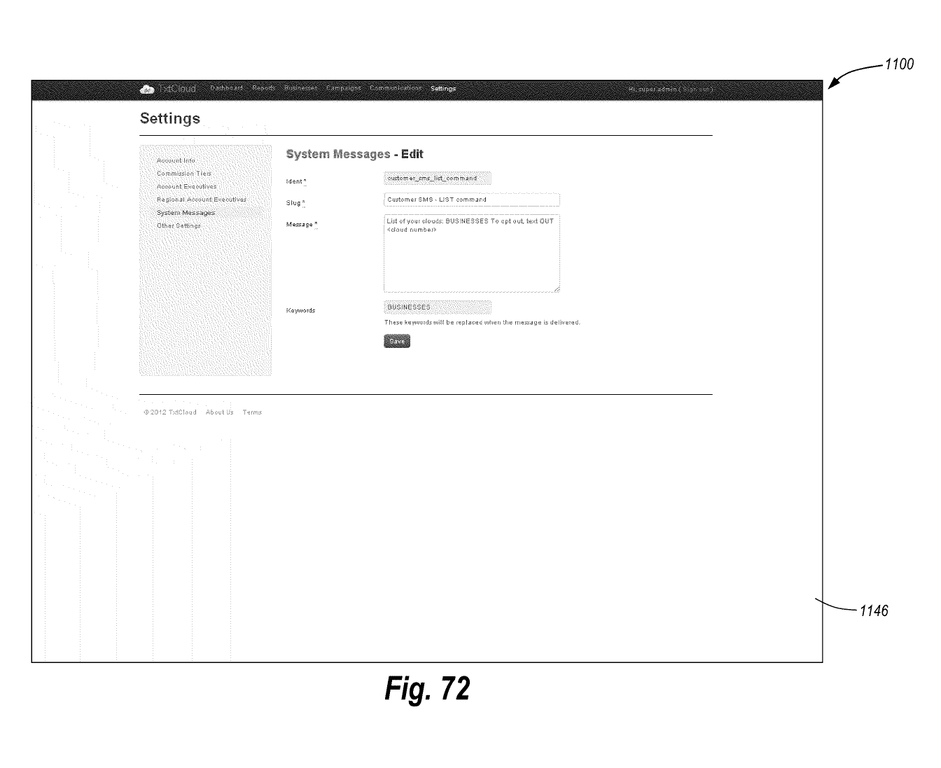

In contrast to advertisements from advertisers, the messages in the interface view 1142 of FIG. 70 may represent messages sent by the service provider related to the service. Of course, the service provider may also add, edit or remove messages at any time. For instance, other messages may be provided to change information (e.g., sending a message with “ZIP” followed by a five digit number will change his or her zip code). FIG. 71, illustrates a view 1144 for adding a new message by including the message along with an identifier, and short description. Keywords may also be noted and if found in the message body, may be replaced with relevant information when the message is sent. FIG. 72 shows a similar view 1146, but for editing an existing message.

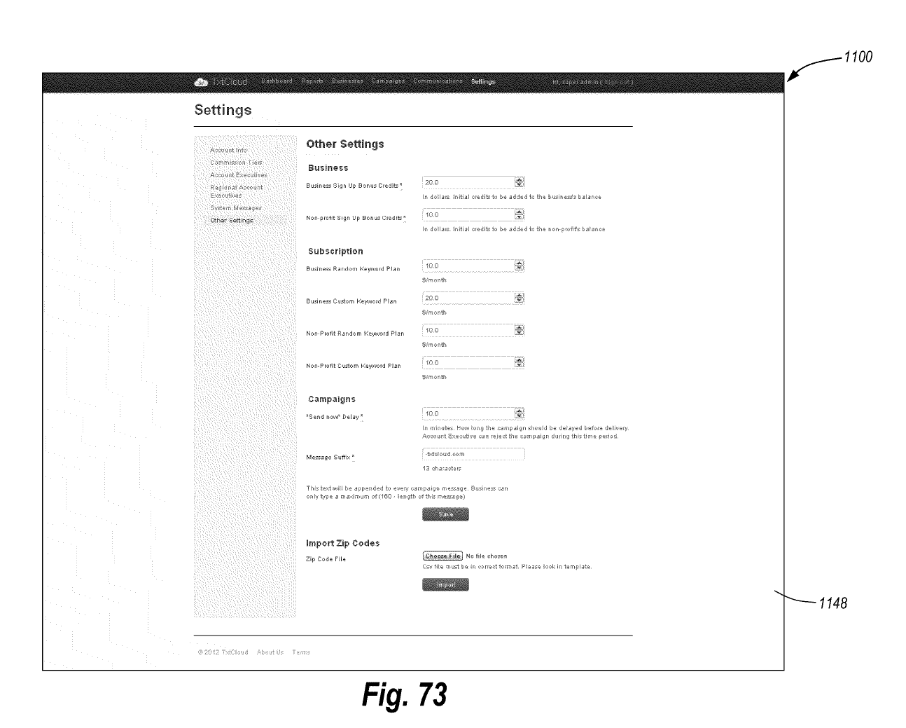

Any other settings may also be included. FIG. 73, for instance, provides a view 1148 of additional settings. In this embodiment, the settings may relate to credits, costs, message processing, or other information. As an example, a Business section may indicate what credits, if any, are given to new businesses or non-profits that sign-up for the messaging service and create accounts. The Subscription section may provide costs (e.g., monthly subscription costs) for business and non-profits based on the type of plan selected (e.g., random vs. custom keyword, high response customers vs. no preference on customers, etc.). The Campaigns section may provide for a delay in sending messages of a campaign. Such a delay may allow an account executive or manager to review and potentially reject the campaign. The section also includes an illustrative section for indicating a suffix or message to include at the end of every advertising message sent. Finally, the illustrated view 1148 in FIG. 73 may also include an option to import zip codes or other data for geographically identifying locations.

The views and interfaces in the figures are merely illustrative, and should not be interpreted as including a comprehensive list of available features, nor as requiring that any particular feature be present or combined with any other feature. Accordingly, a wide variety of features and options may be provided in connection with messaging systems and interfaces, any of which may be used by a consumer, an advertising entity (including one or more employees or representatives), or service provider (including one or more employees, account managers, or representatives).

The described embodiments of systems and methods are merely illustrative. In other embodiments, for instance, additional steps, acts, user interfaces, views, processes, and the like may be included. Embodiments of the present disclosure may comprise or utilize a special purpose or general-purpose computer including computer hardware, such as, for example, one or more processors and system memory, as discussed in greater detail herein. Embodiments within the scope of the present disclosure also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the disclosure can comprise at least two distinctly different kinds of computer-readable media, including at least computer storage media and/or transmission media.

Examples of computer storage media include RAM, ROM, EEPROM, CD-ROM or other optical disk storage, magnetic disk storage or other magnetic storage devices, or any other non-transmission medium which can be used to store desired program code means in the form of computer-executable instructions or data structures and which can be accessed by a general purpose or special purpose computer.

A “communication network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmissions media can include a communication network and/or data links, carrier waves, wireless signals, and the like, which can be used to carry desired program or template code means or instructions in the form of computer-executable instructions or data structures and which can be accessed by a general purpose or special purpose computer. Combinations of physical storage media and transmission media should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above, nor performance of the described acts or steps by the components described above. Rather, the described features and acts are disclosed as example forms of implementing the claims.

Those skilled in the art will appreciate that the embodiments may be practiced in network computing environments with many types of computer system configurations, including, personal computers, desktop computers, laptop computers, message processors, hand-held devices, programmable logic machines, multi-processor systems, microprocessor-based or programmable consumer electronics, network PCs, tablet computing devices, minicomputers, mainframe computers, mobile telephones, PDAs, pagers, routers, switches, and the like.

Embodiments may also be practiced in distributed system environments where local and remote computer systems, which are linked (either by hardwired data links, wireless data links, or by a combination of hardwired and wireless data links) through a network, both perform tasks. In a distributed computing environment, program modules may be located in both local and remote memory storage devices.

Although the foregoing description contains many specifics, these should not be construed as limiting the scope of the invention or of any of the appended claims, but merely as providing information pertinent to some specific embodiments that may fall within the scopes of the invention and the appended claims. Various embodiments are described, some of which incorporate differing features. The features illustrated or described relative to one embodiment are interchangeable and/or may be employed in combination with features of any other embodiment herein. In addition, other embodiments of the invention may also be devised which lie within the scopes of the invention and the appended claims. The scope of the invention is, therefore, indicated and limited only by the appended claims and their legal equivalents. All additions, deletions and modifications to the invention, as disclosed herein, that fall within the meaning and scopes of the claims are to be embraced by the claims.

What is claimed is:

1. A method for distributing messages to consumers, comprising:
receiving, from an advertiser, a request to send a message;
identifying a plurality of recipients;
sending the message to the plurality of recipients, including at least one recipient associated with a charitable organization identified to receive contributions based on messages received by the at least one recipient;
charging the advertiser a fee for sending of the message to the plurality of recipients; and
determining a payment due to the charitable organization, the payment being due as a result of sending the message to the at least one recipient.

2. The method of claim 1, wherein the advertiser is one or more of a business, non-profit, or charity.

3. The method of claim 1, wherein sending the message includes sending a text message to the plurality of recipients.

4. The method of claim 1, wherein identifying the plurality of recipients includes identifying a plurality of recipients from a cloud specific to the advertiser.

5. The method of claim 1, wherein identifying the plurality of recipients includes identifying a plurality of recipients from a cloud associated with a third party, and which the third party shared with the advertiser.

6. The method of claim 1, wherein identifying the plurality of recipients includes identifying a plurality of recipients from a cloud of one or more geographically proximate third parties.

7. The method of claim 1, further comprising:
receiving from the plurality of consumers opt-in message opting in for a particular advertiser and allowing use by other advertisers.

8. The method of claim 1, wherein determining a payment due to the charitable organization includes making payment to the charitable organization.

9. The method of claim 1, wherein determining a payment due to the charitable organization includes calculating an amount based on the fee charged to the advertiser.

10. The method of claim 1, wherein determining a payment due to the charitable organization is based on the equation:
$$C = \frac{F}{N} p ,$$
where C is the payment, F is the fee received, N is a total number of messages sent to the plurality of recipients, and p is a percentage between 1% and 50%.

11. The method of claim 1, wherein determining a payment due to the charitable organization includes calculating an amount fixed on a per-message basis.

12. A method for distributing messages to consumers, comprising:
receiving a request from a consumer to opt-in to a message advertising campaign, the request including a keyword associated with a particular advertiser;
adding the consumer to a customer cloud for the advertiser; and
adding the consumer to a general cloud for additional advertisers not identified in the request to opt-in to the message advertising campaign.

13. The method recited in claim 12, further comprising:
sending a message to the consumer, the message being specified by the advertiser for sending to customers in the advertiser's customer cloud.

14. The method recited in claim 12, wherein the advertiser is a first advertiser sharing its customer cloud with a second advertiser, the method further comprising:
sending a message to the consumer, the message being specified by the second advertiser for sending to customers in the first advertiser's cloud due to it being shared with the second advertiser.

15. The method recited in claim 12, wherein the general cloud includes a cloud for geographically proximate additional advertisers.

16. The method recited in claim 12, further comprising:
sending a message to the consumer on the basis that the consumer has opted-in to the advertising campaign; and
determining a payment due to the charitable organization, the payment being due as a result of sending the message to at least the consumer.

17. The method recited in claim 16, further comprising:
identifying the charitable organization.

18. The method recited in claim 17, wherein identifying the charitable organization includes identifying a charitable organization specified by the consumer.

19. The method recited in claim 12, further comprising:
receiving from a consumer a set of one or more messaging restrictions.

20. A system for distributing messages to consumers, comprising:
one or more processors;
one or more computer storage media in communication with the one or more processors and having stored thereon computer-executable instructions that, when executed by the one or more processors, causes the system to perform the method of claim 12.
